(19) United States
(12) Patent Application Publication
(10) Pub. No.: US 2023/0081927 A1
(43) Pub. Date: Mar. 16, 2023

(54) QUANTUM-COMPUTING BASED METHOD AND APPARATUS FOR ESTIMATING GROUND-STATE PROPERTIES

(71) Applicant: Zapata Computing, Inc., Boston, MA (US)

(72) Inventors: Ruizhe Zhang, Austin, TX (US); Guoming Wang, North York (CA); Peter D. Johnson, Portland, ME (US)

(21) Appl. No.: 17/946,554

(22) Filed: Sep. 16, 2022

Related U.S. Application Data
(60) Provisional application No. 63/244,849, filed on Sep. 16, 2021.

(51) Int. Cl. G06N 10/60

(52) U.S. Cl. CPC G06N 10/60

(57) ABSTRACT

A method and apparatus are disclosed for estimating ground state properties of molecules and materials with high accuracy on a hybrid quantum-classical computer using low-depth quantum circuits. The ground stat energy is estimated for a Hamiltonian (H) matrix characterizes a physical system. For an observable (O), samples are run on a parameterized Hadamard test circuit, the outcomes are evaluated, and the expectation value (p₀) of the observable (O) is estimated with respect to the ground state energy. A weighted expectation value p₀O₀ is estimated, and the ground state property [symbol] ψ₀|O|ψ₀ [symbol] is calculated. Applications include Green's functions used to compute electron transport in materials, and the one-particle reduced density matrices used to compute electric dipoles of molecules. In another aspect, the disclosed technology is applicable to early fault-tolerant quantum computers for carrying out molecular-level and materials-level calculations.

### BACKGROUND

### Field of the Technology Disclosed

The field of the disclosed technology is that of estimating ground state properties for molecules and materials using quantum computers.

### Description of Related Art

The subject matter discussed in this section should not be assumed to be prior art merely because of its mention in this section. Similarly, any problems or shortcomings mentioned in this section or associated with the subject matter provided as background should not be assumed to have been previously recognized in the prior art. The subject matter in this section merely represents different approaches, which in and of themselves may also correspond to implementations of the claimed technology.

Quantum computers have been improving at a rapid rate, increasing the demand for quantum algorithms with high-impact use cases. As quantum technology is commercialized, quantum computing technology will make possible the development of new molecules and materials, including new drug discovery. One of the primary applications of quantum computing is the simulation of materials and molecules, which are inherently quantum mechanical. Quantum algorithm development for quantum chemistry and materials has been focused on ground state energy estimation. This problem is mathematically formulated as estimating the lowest eigenvalue of the Hamiltonian matrix that characterizes the physical system. One of the first quantum chemistry applications of quantum computers was the use of quantum phase estimation for estimating the ground state energy of small molecules.

However, in characterizing materials or analyzing small molecules for drug discovery, one often needs to estimate properties of the ground state beyond the ground-state energy. These estimates include the calculation of transport properties, electric dipoles, and molecular forces.

These ground state properties depend on expectation values of observables (O) with respect to the ground state of a Hamiltonian (H). The problem of estimating such ground state properties has been found to be significantly more complex, in the theoretical sense, than the ground state energy estimation problem in general.

One drawback of current quantum circuits and algorithms is that such algorithms were developed for ideal quantum computers. These algorithms require high-depth quantum circuits, having many quantum gates in which errors propagate more readily, making them impractical for implementation on present-day quantum computers.

One near-term approach has been to use the variational quantum eigensolver algorithm (VQE) to provide a means for preparing an approximation to the ground state, from which each ground state property can be estimated iteratively. However, recent research suggests that VQE alone is not practical for solving problems of industrial relevance, such as solving quantum chemistry problems with small molecules. Also, current published information suggests that VQE may not outperform state-of-the-art classical methods and cannot guarantee the accuracy of the ground state estimation. Furthermore, training quantum circuits becomes difficult because of barren plateaus and other factors. The disclosed technology overcomes many of the drawbacks of the VQE methods and its variants for estimating ground state properties.

### SUMMARY

The disclosed technology uses a different approach for estimating ground state properties, which can be used with near-term quantum computers. The disclosed technology is more accurate and more reliable than known variational quantum eigensolver (VQE) methods.

In one aspect, the disclosed technology provides a quantum-classical algorithm that estimates [symbol] ψ₀|O|ψ₀ [symbol] with high accuracy and low circuit depth. The disclosed algorithm and quantum circuit can be used to reliably estimate ground state properties of a Hamiltonian using early or near-term fault-tolerant quantum computers and may be implemented with a low-depth quantum circuit.

In another aspect, the maximal Hamiltonian evolution time is Õ(Δ⁻¹), where Δ is the spectral gap of H. The total evolution time is Õ(Δ⁻¹ϵ⁻²η⁻²), where ϵ is the additive error and η≤| [symbol] ϕ₀|ψ₀ [symbol] |². The number of times needed to run the quantum circuit is O (ϵ⁻²η⁻²).

In another aspect, the algorithm works for any observable. Also, the quantum circuit is a variant of the Hadamard test circuit [symbol] ψ₀|O|ψ₀

[symbol]

The disclosed technology is particularly useful for applications in quantum chemistry, characterizing small molecules, and materials research. In a further aspect, the technology may be used for estimating transport properties via an estimation of Green's functions. The disclosed technology may also be useful for extracting quantities from the solution of a linear system of equations.

In one embodiment of the disclosed technology, a system is provided for ground state property estimation (GSPE) using a hybrid quantum-classical (HQC) computer system. The computer system comprises classical computer elements and quantum computer elements. The classical computer elements include at least one processor and a non-transitory computer-readable memory, the non-transitory computer-readable memory storing computer instructions. The instructions, when executed by the classical processor, perform the method of estimating a ground state property of an observable (O). In one aspect, the classical computer elements also provide instructions and parameterized data to the quantum computer elements for executing algorithms and setting the initial quantum state of the quantum computer elements. The quantum computer elements may include a number of qubits and quantum gates configured in a quantum circuit. As part of the disclosed GSPE method, the quantum computer elements run a ground state property estimation algorithm. In another aspect, the classical computer elements further provide postprocessing of the data received from the quantum computer elements and provide the actual computation of the ground state properties based on a plurality of runs of the GSPE algorithm.

In another embodiment, a method is provided for estimating a ground state property (GSPE) of an observable (O). The method operates on a hybrid quantum classical (HQC). In one aspect, an initial quantum state is prepared with qubit registers and, ideally, one ancilla qubit. The ground state energy of a Hamiltonian (H) matrix is first estimated that characterizes a physical system. In another aspect, a plurality of samples are generated from a parameterized Hadamard test circuit. The sample outcomes are then evaluated. An estimate is made for the expectation value (p₀) of the observable (O) with respect to the ground state energy. Following this, an estimate is made for the weighted expectation value p₀O₀. An estimate of the ground state property [symbol] ψ₀|O|ψ₀ [symbol] is then computed.

In one aspect of the disclosed technology, the physical system may be a molecule. In another aspect of the disclosed technology, the method may be used for estimating ground state properties for Green's functions. Further, the disclosed method may be used with Green's functions for computing electron transport in materials. In a still further aspect of the disclosed technology, the Green's functions may be used for computing electric dipoles of molecules. The disclosed method may also be used for computing the charge density of a molecule. Also, the charge density may be determined from the one-particle reduced density matrix. In another aspect, the physical system may be a material.

In a further aspect of the disclosed technology, the ground state property estimation may use a low-depth quantum circuit with reduced error rates. In one aspect, circuit depth may be determined as the inverse spectral gap and poly-logarithmic in the inverse target accuracy and inverse initial overlap, which will be described further on.

The disclosed method may also be used as a quantum linear system solver for extracting quantities from the solution of a linear system of equations. The efficiency may be augmented using the filter diagonalization method, as described.

The disclosed technology is applicable to estimating ground state properties using known fault-tolerant computers.

In another aspect, the disclosed technology may be combined with other methods, such as the variational quantum eigensolver VQE or the quantum approximate optimization algorithm (QAQO).

In another embodiment of the disclosed technology, an algorithm is presented for estimating the ground state energy property of an observable (O), wherein the algorithm (1) estimates ground state energy, (2) estimates the expectation value of the observable (O) with respect to the ground state P_{P0}, and (3) estimates the weighted expectation values p₀O₀.

In another embodiment, a system is provided for estimating ground state properties of an observable (O) comprising a hybrid quantum-classical computer (HQC), the computer comprising a quantum computing component having a plurality of qubits, and a classical computing component. The classical computer includes at least one processor and a non-transitory computer-readable memory, the non-transitory computer-readable memory storing computer instructions. The computer instructions, when executed by the classical processor, perform a method for estimating a ground state property of an observable (O). The system performs a method of first initializing the quantum component to an initial state with qubit registers. Next, the method estimates the ground state energy of a Hamiltonian (H) matrix that characterizes a physical system. The system then generates a plurality of samples from a parameterized Hadamard test circuit. The sample outcomes are evaluated, and an expectation value (p₀) of the observable (O) is estimated with respect to the ground state energy. Finally, a weighted expectation value p₀O₀ it is estimated and used to derive an estimate of the ground state property [symbol] ψ₀|O|ψ₀ [symbol] .

In further aspects, the qubit registers may include a single ancilla bit. The physical system may be a molecule. The disclosed system may be used to compute the charge density of a molecule. Also, the charge density of the molecule may be determined using the one-particle reduced density matrix. Alternatively, the physical system may be a material.

### DESCRIPTION OF THE DRAWINGS

In the drawings, like reference characters designate like parts throughout the different views. Also, the drawings are not necessarily to scale, with an emphasis instead generally being placed upon illustrating the principles of the technology disclosed. In the following description, various implementations of the technology disclosed are described with reference to the following drawings.

FIG. 1 is a diagram of a quantum computer according to one embodiment of the present invention;

FIG. 2A is a flowchart of a method performed by the quantum computer of FIG. 1 according to one embodiment of the present invention;

FIG. 2B is a diagram of a hybrid quantum-classical computer which performs quantum annealing according to one embodiment of the present invention;

FIG. 3 is a diagram of a hybrid quantum-classical computer according to one embodiment of the present invention.

FIG. 4 is a simplified block diagram of the disclosed technology for ground state property estimation;

FIG. 5 illustrates the disclosed algorithm for ground state property estimation (GSPE) and method in flowchart form;

FIG. 6 illustrates an Algorithm 1 for ground state energy estimation (GSEE) in pseudocode;

FIG. 7 illustrates a Hadamard test circuit shown used for ground state energy estimation;

FIG. 8 illustrates a quantum circuit for estimating the expectation value of O;

FIG. 9 illustrates an Algorithm 2 for ground state property estimation (GSPE) (commutative case) in pseudocode;

FIG. 10(a) shows the integral region for Equation 44, where the integral in regions 1-6 can be upper bounded by Equation 43;

FIG. 10(b) shows the integral region for equation 45(a) is the integral region for Equation 46, where the integral in regions 1-6 can be upper-bounded by Equation 45;

FIG. 11 shows a parameterized quantum circuit used for estimating the 2-d O-weighted ACDF [symbol] (x, y);

FIG. 12a illustrates a point that is good for λ₀, wherein the individual in parentheses is the approximation region such that [symbol] (x_{good}) is close to C(x) for some x in this interval;

FIG. 12(b) shows a good point in the 2-d case, wherein the large square indicates the 2-d O-weighted CDF C_{0,2} takes the same value C_{0,2}(λ₀, λ₀). And the smaller square with hatching is the approximation region of (x_{good}, y_{good}) such that [symbol] (x_{good}, y_{fgood}) is close to some C_{0,2} (x, y) in this region;

FIG. 13 illustrates an Algorithm 3 for ground state property estimation (GSPE) (general case) in pseudocode; and

FIG. 14 shows the parameterized quantum circuit for estimating [symbol] ϕ₀|e^{-it}^{₂}^{H}_{Oe}^{-it} ^{₁}^{H}|ϕ₀ [symbol] for certain t₁, t₂ ∈ [symbol] , in which controlled-O must be a unitary operation.

### DETAILED DESCRIPTION

The following detailed description is made with reference to the figures. Sample implementations are described to illustrate the technology disclosed, not to limit its scope, which is defined by the claims. Those of ordinary skill in the art will recognize a variety of equivalent variations on the description that follows.

Quantum computers have been proven useful in solving difficult computational problems that are difficult for classical computers. One of the areas of current interest is solving problems related to ground state properties, such as those that would be involved in molecular structure and material properties. Although advances in quantum computers will continue to develop in coming years, there is a need to solve problems with currently available quantum computer architecture hardware.

In one aspect of the disclosed technology, an algorithm is provided for calculating the ground state energy and ground state properties using present generation quantum technology. The disclosed technology includes an algorithm that operates with low depth quantum circuits. The present technology improves on these earlier algorithms and quantum circuits by providing a highly accurate, high probability, low circuit depth solution for estimating ground state properties, which can be implemented on current or near-term fault-tolerant quantum computers.

Overview

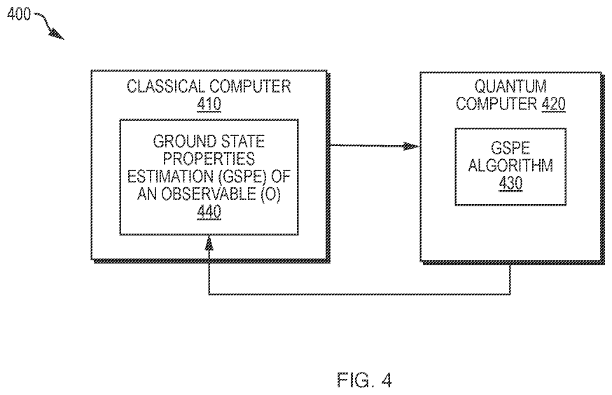

FIG. 4 is a simplified illustration of a system for ground state property estimation (GSPE) using a hybrid quantum-classical (HQC) computer system. The computer system comprises classical computer 410 elements and quantum computer 420 elements. The classical computer 410 elements include at least one processor and a non-transitory computer-readable memory, the non-transitory computer-readable memory storing computer instructions. The instructions, when executed by the classical processor, perform the method of estimating a ground state property of an observable (O). The classical computer 410 elements also provide instructions and parameterized data to the quantum computer 430 elements for executing algorithms and setting the initial quantum state of the quantum computer 420 elements. The quantum computer 420 elements may include a number of qubits and quantum gates configured in a quantum circuit. As part of the GSPE method, the quantum computer 420 elements run a ground state property estimation algorithm 430. The classical computer elements 410 further provide postprocessing 440 of the data received from the quantum computer 420 elements, providing the actual computation of the ground state properties based on a plurality of runs of the GSPE algorithm.

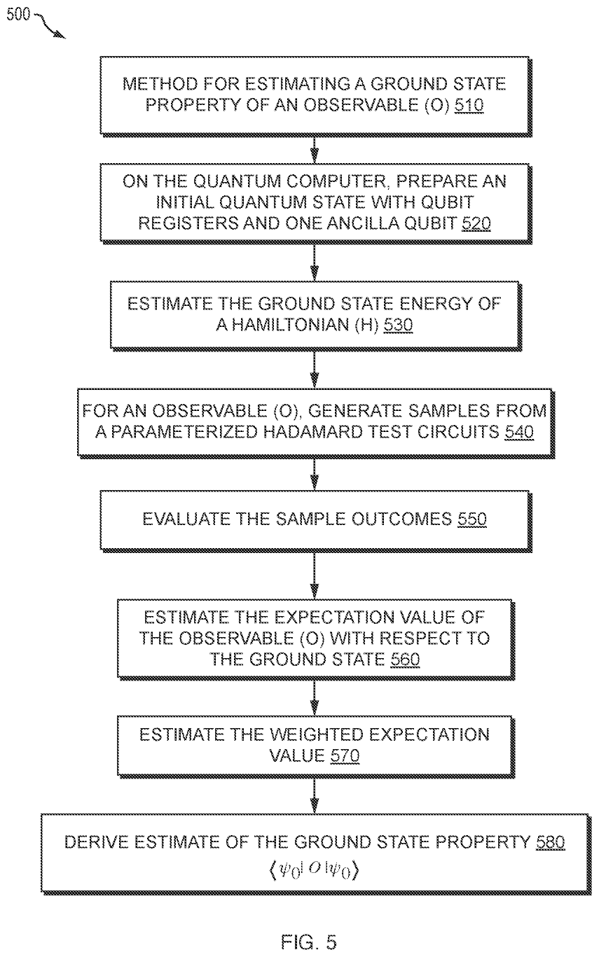

Referring now to FIG. 5, a block diagram is shown of the disclosed method 500 for estimating a ground state property (GSPE) of an observable (0), 510, according to one embodiment of the present invention. In step 520, on the quantum computer, an initial quantum state is prepared with qubit registers and one ancilla qubit. In step 530, the ground state energy of a Hamiltonian (H) matrix is estimated that characterizes a physical system. In step 540, samples are generated from me parameterized Hadamard test circuit. In step 550, the sample outcomes are evaluated. In step 560, an estimate is made for the expectation value (_{Po}) of the observable (0) with respect to the ground state energy. In step 570, an estimate is made for the weighted expectation value _{Po} 0₀. Finally, in step 580, an estimate of the ground state property [symbol] ψ₀|O|ψ₀ [symbol] is computed.

### Reduced Depth of The Quantum Circuit

The maximal evolution time, which is the maximal length of time used to perform coherent time evolution, can roughly determine the depth of the quantum circuit. Hence, the disclosed algorithm has a great advantage when the Hamiltonian's spectral gap is much larger than the estimation accuracy, making it easier to be implemented in the early fault-tolerant devices.

In one embodiment, a quantum-classical hybrid algorithm is disclosed for estimating properties of the ground state of a Hamiltonian, such that the quantum circuit depth is relatively small. Therefore, the algorithm has a significant advantage in high-accuracy estimation, and may be implemented in early fault-tolerant devices. In practice, the disclosed algorithm can solve many important tasks by combining with some initial state preparation methods (e.g., those used for VQE or QAOA).

### Example Embodiment of The Algorithm

Theorem 1. Given a Hamiltonian H and an observable O. Assume access to a unitary U_{I} that prepares a state |φ₀ [symbol] that has non-trivial overlap with the ground state |ψ₀ [symbol] of H. then, there exists an algorithm to estimate [symbol] ψ₀|O|ψ₀ [symbol] with high accuracy and low-depth: the maximal Hamiltonian evolution time is (γ⁻¹), where y is the spectral gap of H.

First, it can be noted that the maximal evolution time, which is the maximal length of time needed to perform coherent time evolution, may roughly determine the depth of the quantum circuit. The result achieves a nearly-linear dependence on γ⁻¹ and only poly-logarithmic on the accuracy ϵ⁻¹, which improves the Õ(ϵ⁻¹) maximal evolution time in the ground state energy estimation algorithms. Second, the result does not violate the Heisenberg limit because the total evolution time still depends on poly (ϵ⁻¹). Third, similar to almost all prior works in ground state preparation and energy estimation, it is assumed that the initial state has some nontrivial overlap with the ground state; otherwise, the problem will be computationally intractable. Last, the Hamiltonian may be considered a black-box, which is a common model in this field. To implement the algorithm, for sparse local Hamiltonian, current state-of-the-art Hamiltonian simulation methods may be used, wherein gate complexity depends linearly in the evolution time and logarithmically in the accuracy.

### Comparison to the Straightforward Method

The disclosed algorithm may be compared with the straightforward approach of GSPE that first prepares the ground state and then applies quantum phase estimation (QPE) to estimate the ground state property.

In the first step, to achieve an E-accuracy for the estimation, the ground state needs to be prepared with fidelity at least 1−ϵ, using known methods, which have circuit depth Õ(γ⁻¹η⁻¹) where η is the overlap between the initial state and the ground state.

In the second step, QPE requires circuit depth Õ(γ⁻¹) for an E-accuracy estimation for the ground state property.

Therefore, this straightforward approach has circuit depth Õ(γ⁻¹η⁻¹+ϵ⁻¹) while the algorithm has circuit depth Õ(γ⁻¹). Furthermore, many (e.g., ω(1)) additional ancilla qubits are needed for preparing the ground state, where the disclosed algorithm requires only one ancilla qubit. The disclosed algorithm is advantageous, for example, when the Hamiltonian's spectral gap is much larger than the estimation accuracy, making it easier to be implemented in the early fault-tolerant devices.

### Ground State Property Estimation Problem

The ground state property estimation problem is defined as follows: Problem 1. Approximate simulation (APX-SIM). Given a k-local Hamiltonian H, an [symbol] -local observable O, and real numbers a, b, ϵ such that b-a≥1/poly (n), and ϵ≥1/poly (n), for n the number of qubits the Hamiltonian H acts on, decide:

Yes case: H has a ground state |ψ₀ [symbol] such that (ψ₀|O|ψ₀ [symbol] ≤a,

No case: for any state |ψ [symbol] with [symbol] ψ|H|ψ [symbol] ≤λ₀+ϵ where λ₀ is the ground state energy of H, it holds that [symbol] ψ₀|O|ψ₀ [symbol] ≥b.

APX-SIM is shown to be P^{QMA[|og]}-complete even for 5-local Hamiltonian and 1-local observable, and also for some physics models like 2D Heisenberg model and 1D nearest-neighbor, translationally invariant model. However, these previous studies focused only on the decision version of this problem. For the purpose of designing efficient algorithms, the “search version” of APX-SIM is defined as follows:

Problem 2. Search version of APX-SIM. Given a Hamiltonian H, an (local) observable O, and ϵ∈ (0,1), with Ω(1) probability, estimate [symbol] ψ₀|O|ψ₀ [symbol] with an additive/multiplicative error at most ϵ.

In general, Problem 2 will not be more tractable than Problem 1. Thus, prior information about the Hamiltonian H and its ground state may be needed. Motivated by the widely used variational quantum eigensolver(VQE) and the Hartree-Fock method in quantum chemistry, it is often the case that for many real-world Hamiltonians, an initial state |Φ₀) may be efficiently prepared that has a nontrivial overlap with the ground state. Moreover, the Hamiltonian H may be assumed to have a nontrivial spectral gap, wherein a large family of Hamiltonians satisfy this condition. With these assumptions, the ground state property estimation problem may be defined as follows:

Problem 3. Ground state property estimation (GSPE). Given a Hamiltonian H with spectral gap γ and ground state |ψ₀), an observable O, a unitary U_{I} such that it prepares an initial state |Φ₀) with | [symbol] Φ₀|ψ₀ [symbol] |²≥η, and ϵ∈(0,1), estimate [symbol] ψ₀|O|ψ₀ [symbol] with an additive/multiplicative error at most ϵ with Ω(1) probability.

Remark 4. When O=H, Problem 3 becomes the ground state energy estimation problem. Moreover, prior knowledge of a large overlap for the initial state is required for all quantum algorithms with provable performance guarantees. It is also worth noting that even with these assumptions, it is unlikely to use a purely classical algorithm to estimate the ground state energy or property to high precision (unless P=BQP).

A high-accuracy, early fault-tolerant quantum algorithm for GSPE is disclosed that satisfies the following properties:

The maximal evolution time depends logarithmically on the accuracy ϵ and overlap η. In addition to the Hamiltonian evolution and observable implementation, it only uses one additional ancilla qubit.

### An Overview of the Low-Depth Ground State Energy Estimation

Following is a brief overview of a low-depth ground state energy estimation algorithm implemented according to one embodiment of the present invention.

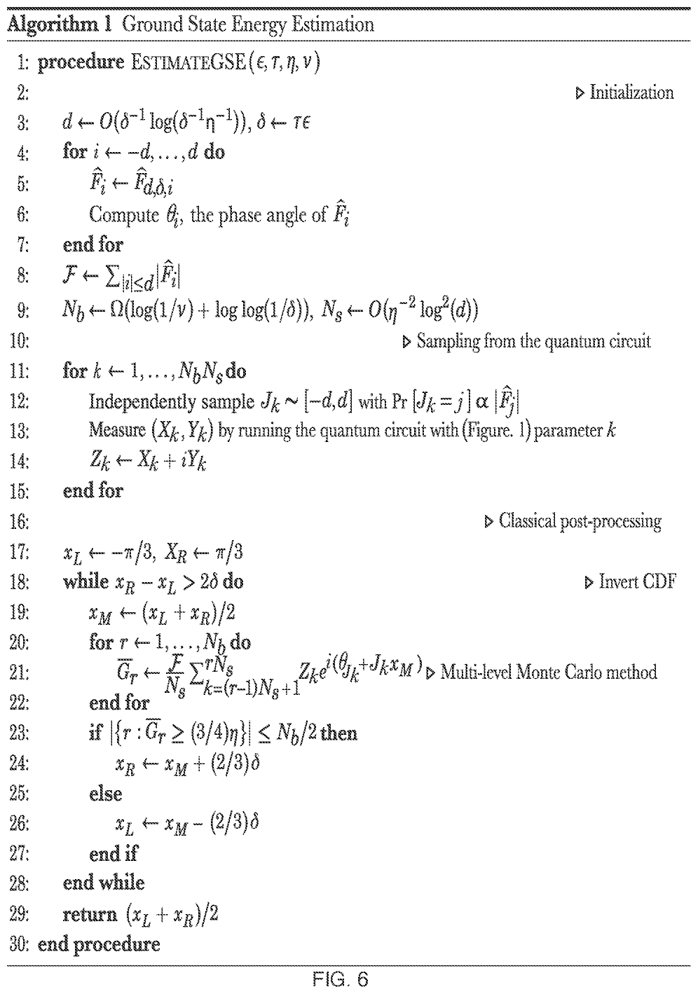

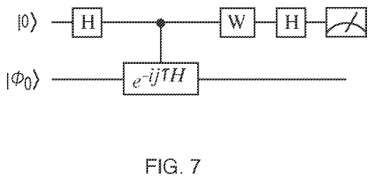

Theorem 1. Given a Hamiltonian H with eigenvalues in the interval [−π/3, π/3] and its ground state |ψ₀ [symbol] has energy λ₀. An initial state |Φ₀) can be prepared such that p₀≥η for some known η, where p₀:=| [symbol] ϕ₀|ψ₀ [symbol] |². Then, for any ϵ, v∈(0,1), there exists an algorithm that estimates λ₀ with an additive error ϵ with probability 1-v, by running a parameterized quantum circuit with the maximum quantum evolution time Õ(ϵ⁻¹) and the expected total quantum evolution time Õ(ϵ⁻¹η⁻²). Example pseudocode of the algorithm is illustrated shown in FIG. 6 as Algorithm 1. The main technique of the algorithm is a classical post-processing procedure that extracts information from the Hadamard test circuit shown in FIG. 7. FIG. 7 shows a quantum circuit parameterized by j. H is the Hadamard gate and W is either I or a phase gate.

Let the initial state |Φ₀ [symbol] be expanded as |Φ₀ [symbol] =Σₖαₖ|ψₖ [symbol] in the eigen-basis of H and let pₖ:=I αₖ|² be the overlap with the k-th eigenstate. The overlaps p₀, p₁, . . . are considered as a density function:

$$p ( x ) := {\sum }_{k} {p}_{k} δ ( x - {λ}_{k} ) ∀ x ∈ [ - π , π ] . \qquad ( 1 )$$

Then, the cumulative distribution function (CDF) C(x):=f_{-π}^{x}p (t)dt can be expressed as a convolution of p(x) and the 2π-periodic Heaviside function H(x), which is 0 in [(2k−1)π, 2kπ) and 1 in [2kπ, (2k+1)π) for any k∈Z. Thus, C(x) is also a periodic function, which makes it convenient to apply the Fourier approximation. Therefore, H(x) can be approximated by a low-Fourier degree function F(x) in the intervals [-π+δ, -δ] and [δ, π-delta]. Then, the approximated cumulative distribution function (ACDF) can be defined as \tilde{C}(x):=(F*p)(x) and proved that

C(x-δ)-η/8≤\tilde{C}(x)≤C(x+δ)+η/8∀x∈[-π/3,π/3,π/3]. (2)

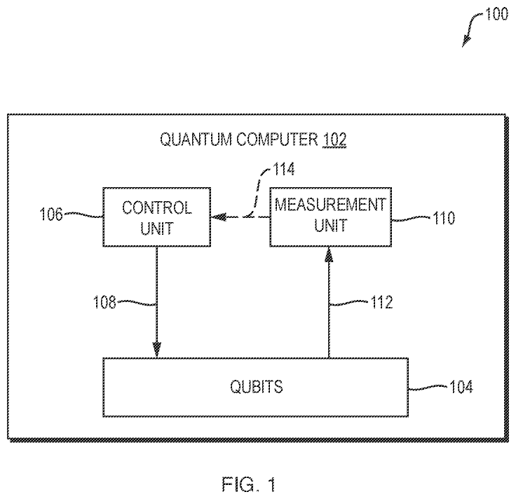

Moreover, for each x:

$$\tilde{C} ( x ) = {\sum }_{\vert j \vert \leq d} {\hat{F}}_{j} {e}^{ijx} \cdot 〈 {ϕ}_{0} \vert {e}^{- ijH} \vert {ϕ}_{0} 〉 , \qquad ( 3 )$$

where \hat{F}ⱼ is the Fourier coefficient of F(x). Note that [symbol] Φ₀|e^{-ijH}|Φ₀ [symbol] can be estimated via the parameterized quantum circuit (FIG. 1). Hence, ACDF may be estimated at every point in [-π/3,π/3]. Moreover, a multi-level Monte Carlo method can be applied to save the number of samples needed to achieve a high-accuracy estimation. Therefore, the ground state energy λ₀ can be estimated by locating the first non-zero point of the CDF C(x), which is π/8-approximated by the ACDF \tilde{C}(x). Since p₀≥η can be assumed, the approximation error and the estimation error of \tilde{C}(x) can be tolerated, and λ₀ can be found via a robust binary search.

The maximal evolution time of this algorithm corresponds to the Fourier degree of F(x), which is Õ(ϵ⁻¹) by the construction, making their algorithm suitable for early fault-tolerant quantum devices.

### Example Algorithm for Commutative Case

Following is a consideration of an easier case, where O is unitary and commutes with the Hamiltonian H, giving a two-step quantum-classical hybrid algorithm for Problem 3. More specifically, suppose the initial state can be expanded in the eigenbasis as follows: |ϕ₀ [symbol] =Σₖcₖ|ψₖ [symbol] with pₖ:=|cₖ|². It is noted that {|ψₖ [symbol] } is also an eigenbasis of O since O and H commute. In Step 1, the algorithm is run to estimate the ground state energy λ₀ and the overlap between the initial state and the ground state p₀. In Step 2, a similar CDF function is constructed for the density ΣₖOₖpₖδ(x-λₖ), where Oₖ:= [symbol] ψₖ|O|ψₖ [symbol] . By evaluating the CDF at λ₀, an estimate O₀ may be obtained.

Step 1: Estimate the Initial Overlap. First, the procedure EstimateGSE (Algorithm 1) is run to estimate the ground state energy λ₀ with an additive error ϵ. Let x* be the output to x* satisfy C(x*+τϵ)≥p₀ and C(x*-τϵ)=0. However, p₀ can only be extracted from ACDF \tilde{C}(x), which satisfies:

C(x-τϵ)-η/8≤\tilde{C}(x)≤C(x+τϵ)+η/8∀x∈[-π/3,π/3]. (4)

If [xτϵ,x+τϵ] contains a “jump” of C(x), i.e., an eigenvalue λₖ, then the approximation error of \tilde{C}(x) will be large.

Hence, a point x is “good” for λₖ if [x-τϵ,x+τϵ] is contained in [τλₖ,τλₖ₊₁). It is easy to see that \tilde{C}(x) will be an η/8-additive approximation of Σ_{j≤k}pₖ if x is good. The goal is to find an x_{good} that is good for λ₀, and estimating \tilde{C}(x_{good}) gives the overlap p₀. The following claim (proposition) provides a way to construct x_{good} using the spectral gap of H.

Claim 1. (Construct x_{good}) Let γ be the spectral gap of the Hamiltonian H. For any ϵ∈E (0,γ/4), x*+τγ/2 is good for λ₀, where x* is the output of ESTIMATEGSE (ϵ,η) (Algorithm 1).

Proof x* satisfies:

$${x}^{*} - τ ϵ < τ {λ}_{0} \leq {x}^{*} + τ ϵ . \qquad ( 5 )$$

$$Thus :$$

$${x}^{*} + τ γ / 2 > τ {λ}_{0} - τ ϵ + τ γ / 2 > τ {λ}_{0} + τ ϵ . \qquad ( 6 )$$

$$And also :$$

$${x}^{*} + τ γ / 2 < τ {λ}_{0} + τ ϵ + τ γ / 2 \qquad ( 7 )$$

$$\leq τ ( {λ}_{1} - γ ) + τ ϵ + τ γ / 2 = τ {λ}_{1} + τ ( ϵ - γ / 2 ) < τ {λ}_{1} - τ ϵ . \qquad ( 8 )$$

Therefore, x* is good for λ₀.

If the ACDF's approximation error is chosen to be η/8, It may be directly changed to ϵη/8 without significantly changing the circuit depth, since by Lemma 8 the degree of F can only blowup by a log factor of ϵ.

Lemma 2. (Estimating the overlap) For any ϵ₀,v∈(0,1), the overlap p₀:=| [symbol] ϕ₀d|ψ₀ [symbol] |² can be estimated with multiplicative error 1±O(ϵ₀) with probability 1−v by running the quantum circuit (FIG. 1) Õ(on₀⁻²η⁻²) times with expected total evolution time Õ(γ⁻¹ϵ⁻²η⁻²) and maximal evolution time O(γ⁻¹).

Proof By claim 1, if the additive error of ground state energy λ₀ is set to be O(γ), then it is possible to construct an x_{good} that is good for λ₀. By Theorem 1, it can be done with maximum quantum evolution time Õ(γ⁻¹) and the expected total quantum evolution time Õ(γ⁻¹η⁻²) . It is necessary to take d=O(δ⁻¹ log (δ⁻¹ϵ₀⁻¹η⁻¹)) (Line 1 in Algorithm 1) to make \tilde{C}(x_{good}) be an O (ϵ₀η)-approximation of p₀, where δ=τγ.

Next, an estimate is made of \tilde{C}(x_{good}) with additive error ηϵ with probability 1-v with an unbiased estimator:

G̅(x;Z,J)= [symbol] Ze^{iθ}^{ⱼ}^{+jx} (9)

for \tilde{C}(x), where Z:=X+iY is measured from the Hadamard test, and/ is a random variable for the Hamiltonian evolution time sampled proportional to the Fourier weight of F, i.e., Pr[j=j]=|\hat{F}ⱼ|/ [symbol] for -d≤j [symbol] eqd and [symbol] :=Σ_{|j|≤d}|\hat{F}ⱼ|.

It can be shown that G̅(x;Z,J) has variance

$$O ( {log}^{2} ( d ) ) ,$$

and one estimate can be obtained with evolution time Õ(τd/log (d)) in expectation. If G̅(x;Z,J) is repeatedly sampled, and the mean is taken of the samples, then by Chebyshev's inequality, the sample complexity is Õ(ϵ₀⁻²η⁻²v⁻²) to have an additive error O(ϵ₀η) with probability 1-v.

Alternatively, the so-called “median-of-means” trick may be used to reduce the sample complexity. More specifically, let N_{g}=O(log (1/v)) and K=O(ϵ₀⁻²). First, m=N_{g}K samples (Z₁, . . . , (Zₘ,Jₘ) are partitioned into N_{g} groups of size K. Then, for any i ∈[N_{g}], the i-th group mean is

$$\overline{{G}_{i}} := \frac{1}{K} {\sum }_{j = 1}^{K} \overline{G} ( x ; {Z}_{( i - 1 ) K + j} , {J}_{( i - 1 ) K + j} ) . \qquad ( 10 )$$

The final estimator is given by the median of these group means, i.e.,

G̅(x):=median(G̅₁, . . . , G̅_{N}_{_{g}}). (11)

By Chernoff bound, it is easy to see that G̅(x) has an additive error at most (ηϵ₀) with probability 1-v. It will imply that multiplicative error is at most 1±O(ϵ₀) since p₀=θ(η). And the sample complexity of G(x) is Ō(ϵ₀⁻²η⁻²). Hence, the expected total evolution time is Ō(γ⁻¹). The same quantum circuit is run to estimate G̅(x), the maximal evolution time is still Õ(γ⁻¹).

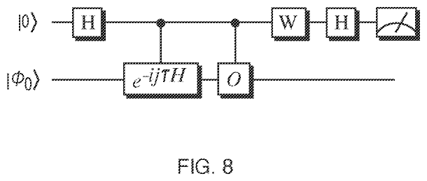

Step 2: estimate the O-weighted CDF. To estimate the expectation value of O, consider the following quantum circuit, illustrated in FIG. 8. The quantum circuit in FIG. 8 is parameterized by j. H is the Hadamard gate and W is either I or a phase gate S. Define the random variables Xⱼ,Yⱼ be as follows: for W=I, Xⱼ:=1 if the outcome is 0, and Xⱼ:=−1 if the outcome is 1. For W=S,Yⱼ:=−1 if the outcome is 0, and Yⱼ:=1 if the outcome is 1. The following claim on the expectation of the random variables Xⱼ,Yⱼ:

Claim 3. (A variant of Hadamard test) For any j∈Z, the random variable Xⱼ+iYⱼ is an unbiased estimator for [symbol] ϕ₀Oe^{-ijτH}|ϕ₀ [symbol] , which can be expanded in the eigenbasis of H (which is also an eigenbasis of O):

$$〈 {ϕ}_{0} \vert O {e}^{- ij τ H} \vert {ϕ}_{0} 〉 = {\sum }_{k , {k}^{′}} {c}_{k}^{*} {c}_{{k}^{′}} {e}^{- ij τ {λ}_{k}} 〈 {ψ}_{k} \vert O \vert {ψ}_{k}^{′} 〉 = {\sum }_{k} {p}_{k} {O}_{k} {e}^{- ij τ {λ}_{k}} , \qquad ( 12 )$$

where the last step follows from the simultaneous diagonalization of O and H, and Oₖ:= [symbol] ψₖ|O|ψₖ [symbol] . An assumption is made that |Oₖ|≤1 for any k∈ [symbol] .

The O-weighted “density function” for the observable is defined as follows:

$${p}_{O} ( x ) := {\sum }_{k} {p}_{k} {O}_{k} δ ( x - τ {λ}_{k} ) . \qquad ( 13 )$$

Note that p₀ (x) can be negative at some points.

Suppose the eigenvalues of τH is within [−π/3,π/3]. Then, O-weighted CDF and ACDF for p₀ (x) are defined as follows:

C₀(x):=(H*p₀)(x), [symbol] (x):=(F*p₀)(x), (14)

where H is the 2π-periodic Heaviside function and F=F_{d,δ} is the Fourier approximation of H constructed by Lemma 8. It is easy to verify that C₀(x) equals to ΣₖpₖOₖ1_{x≥p}_{ₖ}_{O}_{ₖ} for any x∈[−π/3,π/3].
The following lemma gives an unbiased estimator for the O-weighted ACDF.

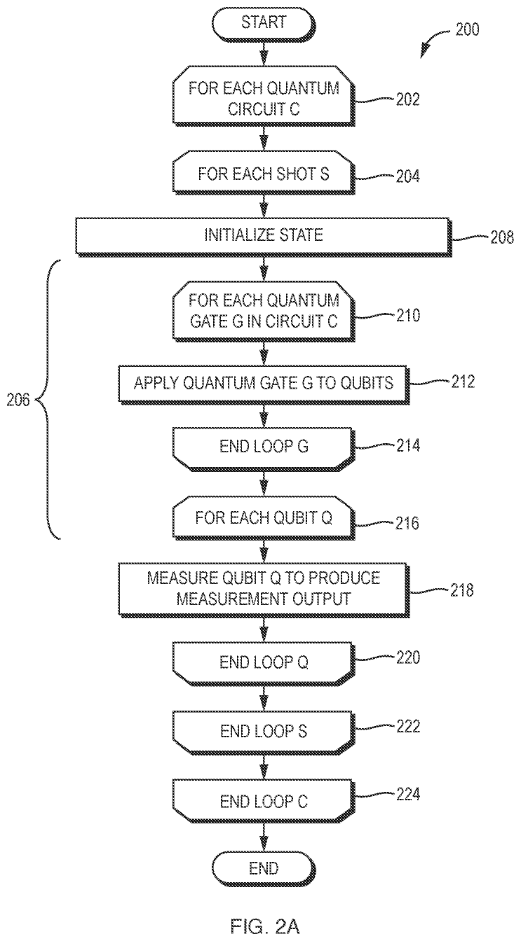

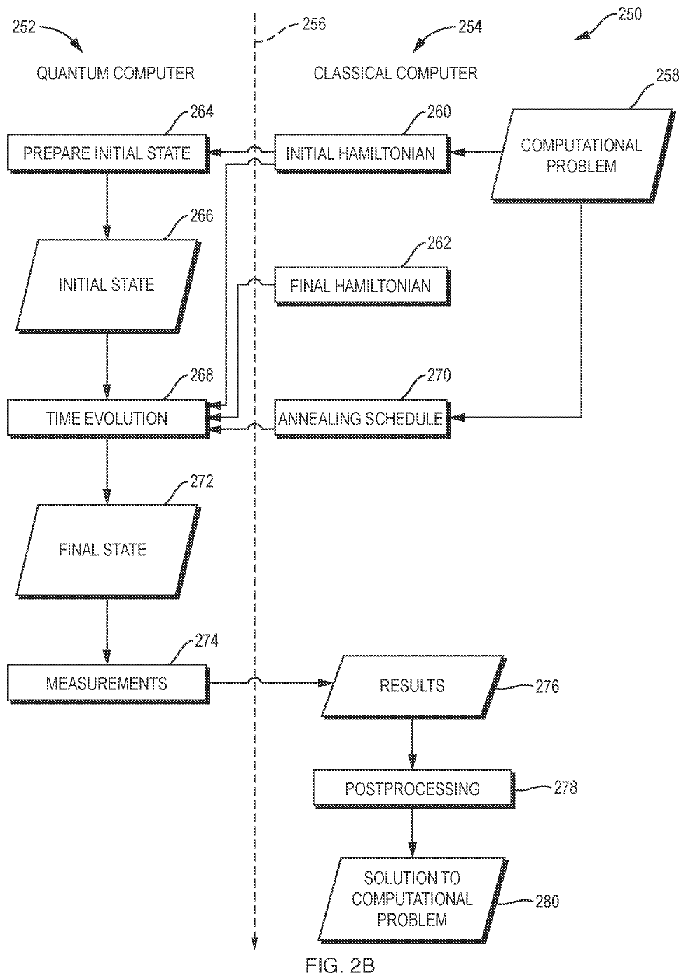

Lemma 4. (Estimating the O-weighted ACDF) For any x∈[−π,π], there exists an unbiased estimator G̅₀̅(x) for the O-weighted ACDF [symbol] (x) with variance Õ(1). Furthermore, G̅₀̅(x) runs the quantum circuit (FIG. 2) with expected total evolution time O(τd/log (d)), where d is the Fourier degree of F.

Proof [symbol] (x) can be expanded in the following way:

$$( x ) = ( F * {p}_{O} ) ( x ) \qquad ( 15 )$$

$${\int }_{- π}^{π} F ( x - y ) {p}_{O} ( y ) dy = {\sum }_{\vert j \vert \leq d} {\int }_{- π}^{π} {\hat{F}}_{j} {e}^{ij ( x - y )} {p}_{O} ( y ) dy = {\sum }_{\vert j \vert \leq d} {\hat{F}}_{j} {e}^{ijx} {\int }_{- π}^{π} {p}_{O} ( y ) {e}^{- ijy} dy = {\sum }_{\vert j \vert \leq d} {\hat{F}}_{j} {e}^{ijx} {\sum }_{k} {p}_{k} {O}_{k} {e}^{- ij τ {λ}_{k}} = {\sum }_{\vert j \vert \leq d} {\hat{F}}_{j} {e}^{ijx} \cdot 〈 {ϕ}_{0} \vert O {e}^{- ij τ H} \vert {ϕ}_{0} 〉 , \qquad ( 16 )$$

where the third step follows from the Fourier expansion of F(x-y), the fifth step follows from the property of Dirac's delta function, and the last step follows from the definition of pₖ and the eigenvalues of matrix exponential.

Define an estimator G(x;J, Z) as follows:

G(x;J,Z):= [symbol] ⋅Ze^{i(θ}^{ⱼ}^{+J}⁾ ,(17)

where θⱼ is defined by \hat{F}ⱼ=\hat{F}ⱼ|e^{iθ}^{ⱼ},Z=X+iY measured from the quantum circuit (FIG. 2) with parameter j=J, and [symbol] =ρ_{|j|≤d}|\hat{F}ⱼ|.

Then, it is shown that that G(x;J, Z) is un-biased:

$$E [ G ( x ; J , Z ) ] = {\sum }_{\vert j \vert \leq d} E [ ( {X}_{j} + {iY}_{j} ) {e}^{i ( {θ}_{j} + jx )} \vert {\hat{F}}_{j} \vert ] \qquad ( 18 )$$

$$= {\sum }_{\vert j \vert \leq d} {\hat{F}}_{j} {e}^{ijx} \cdot E [ {X}_{j} + {iY}_{j} ] = {\sum }_{\vert j \vert \leq d} {\hat{F}}_{j} {e}^{ijx} \cdot 〈 {ϕ}_{0} \vert O {e}^{- ij τ H} \vert {ϕ}_{0} 〉 = \tilde{C} ( x ) , \qquad ( 19 )$$

where the third step follows from claim 3. Moreover, the variance of G can be upper-bounded by:

$$Var [ G ( x ; J , Z ) ] = E [ {\vert G ( x ; J , Z ) \vert}^{2} ] - {\vert E [ G ( x ; J , Z ) ] \vert}^{2} \qquad ( 20 )$$

$$\leq E [ {\vert G ( x ; J , Z ) \vert}^{2} ] \leq 2 {ℱ}^{2} , \qquad ( 21 )$$

where the third step follows from |e^{i(θ}^{ⱼ}^{+Jx)}|=1, and the last step follows from Xⱼ, Yⱼ ∈{±1}. By Lemma 8, it is known that |\hat{F}ⱼ|=0(1//|j|). Hence, it follows that [symbol] =Σ_{|j|≤d}O (1/|j|)=O(log d). Thue, Var {G(x;J,Z)}=O(log(d)). The expected total evolution time is

$${𝒯}_{t o t} := E [ \vert J \vert ] = τ {\sum }_{\vert j \vert \leq d} \vert j \vert \cdot \frac{\vert \hat{{F}_{j}} \vert}{} = O ( τ d / log ( d ) ) . \qquad ( 22 )$$

The lemma is then proved. The following lemma shows that the O-weighted CDF C₀ (x) can be approximated by the O-weighted ACDF C [symbol] (x):

Lemma 5. Approximating the O-weighted CDF For any ϵ>0, 0<δ<π/6, let F(x):=F_{d,δ}(x) constructed by Lemma 8 with approximation error ηϵ/8. Then, for any x∈[-π/3,π/3], it holds that:

C₀(x−δ)−ηϵ/8≤ [symbol] (x)≤C₀(x+δ)+ηϵ/8. (23)

The proof is very similar to Lemma 9, so it is omitted it here.
Assuming δ:=τγ/5 and let x_{good}:=x*+τγ/2. Then, by claim 1, it is known that x_{good} is good for δ₀, i.e., [x_{good}−τγ, x_{good}+τγ]bset (τλ₀,τλ₁). Hence, \tilde{C}_{O}(x_{good}) satisfies

|\tilde{C}₀(x_{good})−p₀O₀|≤ηϵ/8. (24)

The following lemma shows how to estimate [symbol] (x_{good}), which is very similar to Lemma 2.

Lemma 6. (Estimating p₀O₀) For any ϵ₁, v ∈(0,1), p₀O₀ can be estimated with multiplicative error 1±0 (ϵ₁) with probability 1−v by runs the quantum circuit (FIG. 1) Õ(ϵ₁⁻²η⁻²) times with expected total evolution time Õ(γ⁻¹ϵ₁⁻²η⁻²) and maximal evolution time O(γ⁻¹).

### Summarizing the Main Theorem

In this section, the components of the Main theorem are treated together, giving an algorithm for the ground state property estimation.

Theorem 7. (Ground state property estimation with commutative observable) Suppose p₀≥η for some known η, and let γ>0 be the spectral gap of the Hamiltonian. Then, for any ϵ,v∈ (0,1), the ground state property [symbol] ψ₀|O|ψ₀ [symbol] can be estimated within additive error at most n with probability 1−v, such that:
1. the number of times running the quantum circuits (FIGS. 1 and 2) is Õ(ϵ⁻²η⁻²),
2. the expected total evolution time is Õ(γ⁻¹ϵ⁻²η⁻²),
3. the maximal evolution time is Õ(γ⁻¹).

Proof By Lemma 2, an estimate p̅₀̅ for p₀ is obtained with the guarantee that

|p̅₀̅−p₀|≤O(ηϵ₀), 25)

where ϵ₀ will be chosen shortly.
By Lemma 6, an estimate p̅₀̅O̅₀̅ for p₀O₀ is obtained with the guarantee that

|p̅₀̅O̅₀̅−p₀O₀|≤O(ηϵ₁), (26)

where ϵ₁ will be chosen shortly.

### Thus

$$\vert \frac{\overline{{p}_{0} {O}_{0}}}{\overline{{p}_{0}}} - {O}_{0} \vert = \vert \frac{\overline{{p}_{0} {O}_{0}}}{\overline{{p}_{0}}} - \frac{{p}_{0} {O}_{0}}{\overline{{p}_{0}}} + \frac{{p}_{0} {O}_{0}}{\overline{{p}_{0}}} - \frac{{p}_{0} {O}_{0}}{{p}_{0}} \vert \qquad ( 27 )$$

$$\leq \frac{\vert \overline{{p}_{0} {O}_{0}} - {p}_{0} {O}_{0} \vert}{\overline{{p}_{0}}} + \vert {p}_{0} {O}_{0} \vert \vert \frac{1}{\overline{{p}_{0}}} - \frac{1}{{p}_{0}} \vert \leq \frac{O ( {ηϵ}_{1} )}{{p}_{0} - O ( {ηϵ}_{0} )} + \vert {p}_{0} {O}_{0} \vert \vert \frac{1}{{p}_{0} - O ( {ηϵ}_{0} )} - \frac{1}{{p}_{0}} \vert \leq \frac{O ( {ηϵ}_{1} )}{η - O ( {ηϵ}_{0} )} + \vert {p}_{0} {O}_{0} \vert \vert \frac{1}{{p}_{0} - {p}_{0} O ( {ϵ}_{0} )} - \frac{1}{{p}_{0}} \vert \leq O ( {ϵ}_{1} ) ( 1 - O ( {ϵ}_{0} ) ) + \vert {O}_{0} \vert ( 1 + O ( {ϵ}_{0} ) - 1 ) \leq O ( {ϵ}_{0} + {ϵ}_{1} ) , \qquad ( 28 )$$

where the second step follows from the triangle inequality, the third step follows from Eqs. (25) and (26), the third step follows from p₀≥η, the fifth step follows from

$$\frac{1}{1 - x} \leq 1 + O ( x )$$

for x∈(0,1). Hence, by taking ϵ₀=ϵ₁=O(ϵ), an additive error of at most ϵ is achieved.

For the success probability, Eq.(25) can be made with probability 1−v/2 in Lemma 2 and Eq.(26) hold with probability 1−v/2 in Lemma 6. Then, by the union bound, a good estimate is achieved with probability at least 1− v. The computation costs follow directly from Lemma 2 and Lemma 6. And the proof of the theorem is then completed.

FIG. 9 illustrates the ground state property estimation algorithm (commutative case) in pseudocode form.

### Algorithm for General Unitary Observables

In this section, the following theorem for unitary observables in the general case is proved:

Theorem 1. (Ground state property estimation with general unitary observable) Suppose p₁≥η for some known η and the spectral gap of the Hamiltonian H is at least γ. For any ϵ,v∈ (0,1), there exists an algorithm for estimating the ground state property [symbol] ψ₀|O|ψ₀ [symbol] within additive error at most E with probability at least 1−v, such that:
1. the expected total evolution time is Õ(γ⁻¹ϵ⁻²η⁻²)
2. the maximal evolution time is Õ(γ⁻¹).

In the following discussion, the 2-d O-weighted density function and CDF are first introduced, which extend the commuting observables to the general case. Then, it is shown how to combine them with the overlap estimation in Section 4.1 for proving Theorem 1.

2-d O-weighted density function and CDF

Let |ϕ₀ [symbol] =Σₖcₖ|ψₖ [symbol] where |cₖ|²=pₖ. In general, O and H may not commute. Hence, a more symmetric form of expectation: [symbol] ϕ₀|e^{-ijτH}Oe^{-ij′τH}|ϕ₀ [symbol] is considered, which can be expanded in the eigenbasis of H as follows:

$$〈 {ϕ}_{0} \vert {e}^{- ij τ H} {Oe}^{- {ij}^{′} τ H} \vert {ϕ}_{0} 〉 = {\sum }_{k , {k}^{′}} {c}_{k}^{*} {c}_{{k}^{′}} {e}^{- ij {τλ}_{k}} {e}^{- {ij}^{′} {τλ}_{{k}^{′}}} 〈 {ψ}_{k} \vert O \vert {ψ}_{{k}^{′}} 〉 = {\sum }_{k , {k}^{′}} {c}_{k}^{*} {c}_{{k}^{′}} {e}^{- ij {τλ}_{{k}^{′}}} 〈 {ψ}_{k} \vert O \vert {ψ}_{{k}^{′}} 〉 \qquad ( 29 )$$

Similar to the commutative case, a 2-d O-weighted density function is defined as:

$${p}_{O , 2} ( x , y ) := {\sum }_{k , {k}^{′}} {c}_{k}^{*} {c}_{{k}^{′}} {O}_{k , {k}^{′}} δ ( x - τ {λ}_{k} ) δ ( y - τ {λ}_{{k}^{′}} ) , \qquad ( 30 )$$

where O_{k,k′}:= [symbol] ψₖ|ψ_{k′} [symbol] Then, define the corresponding 2-d O-weighted CDF function as follows:

C_{0,2}(x):=(H₂*p_{0.2})(x,y), (31)

where H₂ (x,y):=H(x)⋅H(y), the 2-d 2π-periodic Heaviside function.
It is justified that C_{0,2} is indeed a CDF of p_{0,2} in [−π/3,π/3]:

$${C}_{2} ( x , y ) = {\int }_{- π}^{π} {\int }_{- π}^{π} {H}_{2} ( x - u , y - v ) p ( u , v ) dudv \qquad ( 32 )$$

$$= {\sum }_{k , {k}^{′}} {c}_{k}^{*} {c}_{{k}^{′}} {O}_{k , {k}^{′}} \cdot {\int }_{- π}^{π} {\int }_{- π}^{π} {H}_{2} ( x - u , y - v ) δ ( u - τ {λ}_{k} ) δ ( v - τ {λ}_{{k}^{′}} ) dudv = {\sum }_{k , {k}^{′}} {c}_{k}^{*} {c}_{{k}^{′}} {O}_{k , {k}^{′}} \cdot H ( x - τ {λ}_{k} ) H ( y - τ {λ}_{{k}^{′}} ) = {\sum }_{k , {k}^{′}} {c}_{k}^{*} {c}_{{k}^{′}} {O}_{k , {k}^{′}} \cdot {1}_{x \geq τ {λ}_{k} , y \geq τ {λ}_{{k}^{′}}} = {\sum }_{\begin{matrix}k : τ {λ}_{k} \leq x , ( 33 ) \\ {k}^{′} : {τλ}_{{k}^{′}} \leq y\end{matrix}} {c}_{k}^{*} {c}_{{k}^{′}} {O}_{k , {k}^{′}} . \qquad ( 34 )$$

Hence, the definition of C_{0,2} is reasonable.

Then, it is shown that C_{0,2} can be approximated similar to the 1-d case. Let F₂(x) be the 2-d approximated Heaviside function, i.e.,

F₂(x,y):=F(x)⋅F(y). (35)

The 2-d O-weighted approximated CDF (ACDF) is defined to be

[symbol]

(x,y):=(F₂*p_{0,2})(x,y). (36)

The following lemma shows that [symbol] (x, y) is close to C_{0,2}(x′,y′) for some (x′,y′) close to (x, y).

Lemma 2. Approximation ratio of the 2-d O-weighted ACDF For any ϵ>0,0<δπ/6, let F₂(x,y):=F_{d,δ}(x)⋅F_{d,δ}(y) constructed by Lemma 8. Then, for any x, y ∈[−π/3,π/3], the 2-d O-weighted ACDF [symbol] (x,y)=(F₂* p_{0,2}) (x,y) satisfies:

C_{0,2}(x−δ,y−δ)−2ϵ≥ [symbol] (x,y)≤C_{0,2}(x+δ,y+δ)+2ϵ. (37)

Proof By (2) in Lemma 8, it follows that:

|F(x)−H(x)|≤ϵ∀x ∈[−π+δ,−δ]∪[δ,π−δ], (38)

which implies that for all x, y ∈[−π+δ, −δ]∪[δ,π−δ],

$$\vert {F}_{2} ( x , y ) - {H}_{2} ( x , y ) \vert \leq \vert F ( x ) F ( y ) - H ( x ) H ( y ) \vert = \vert F ( x ) F ( y ) - F ( x ) H ( y ) + F ( x ) H ( y ) - H ( x ) H ( y ) \vert \leq F ( x ) \vert F ( y ) - H ( y ) \vert + H ( y ) \vert F ( x ) - H ( x ) \vert \leq ( F ( x ) + H ( y ) ) ϵ \qquad ( 39 )$$

$$\leq 2 ϵ , \qquad ( 40 )$$

where the last step follows from F(x)∈[0,1] by (1) in Lemma 8. Furthermore, for x ∈[−δ, δ], y ∈[−π+δ, −δ],

$$\vert {F}_{2} ( x , y ) - {H}_{2} ( x , y ) \vert \leq \vert F ( x ) F ( y ) - H ( x ) H ( y ) \vert = \vert F ( x ) F ( y ) \vert \qquad ( 41 )$$

$$H ( y ) = 0 \leq F ( y ) \qquad ( 42 )$$

$$\leq ϵ . \qquad ( 43 )$$

Similarly, for x∈[−π+δ, −δ], y∈[−δ, δ],

|F₂(x,y)−H₂(x,y)|≤ϵ. (44)

Define F_{L,2}:=F₂(x−δ,y−δ) such that

|F_{L,2}(x)−H₂(x)|≤2ϵ∀(x, y) ∈[−π+2δ,0]×[−π+2δ, π]∪[−π+2δ,π]×[−π+2δ, 0]∪[2δ,π]×[2δ,π]. (45).

For [symbol] (x, y):=(F_{L,2}*p_{0,2})(x, y), if follows that [symbol] (x, y)= [symbol] (x−δ,y−δ). Let p₂:=p_{0,2}. Then, for any x, y ∈[−π/3,π/3], it follows that

$$\vert {C}_{O , 2} ( x , y ) - ( x , y ) \vert = \vert {\int }_{- π}^{π} {\int }_{- π}^{π} {p}_{2} ( x - u , y - v ) ( {H}_{2} ( u , v ) - {F}_{L , 2} ( u , v ) ) dudv \vert \qquad ( 46 )$$

$$\leq {\int }_{- π}^{π} {\int }_{- π}^{π} {p}_{2} ( x - u , y - v ) \vert {H}_{2} ( u , v ) - {F}_{L , 2} ( u , v ) \vert dudv = ( {\int }_{- π}^{0} {\int }_{- π}^{π} + {\int }_{0}^{π} {\int }_{- π}^{0} + {\int }_{2 δ}^{π} {\int }_{2 δ}^{π} ) {p}_{2} ( x - u , y - v ) ) \vert {H}_{2} ( u , v ) - {F}_{L , 2} ( u , v ) \vert dudv + ( {\int }_{0}^{2 δ} {\int }_{0}^{π} + {\int }_{0}^{π} {\int }_{0}^{2 δ} - {\int }_{0}^{2 δ} {\int }_{0}^{2 δ} ) {p}_{2} ( x - u , y - v ) ) \vert {H}_{2} ( u , v ) - {F}_{L , 2} ( u , v ) \vert dudv \leq 2 ϵ \cdot ( {\int }_{- π}^{0} {\int }_{- π}^{π} + {\int }_{0}^{π} {\int }_{- π}^{0} + {\int }_{2 δ}^{π} {\int }_{2 δ}^{π} ) {p}_{2} ( x - u , y - v ) dudv + ( {\int }_{0}^{2 δ} {\int }_{0}^{π} + {\int }_{0}^{π} {\int }_{0}^{2 δ} - {\int }_{0}^{2 δ} {\int }_{0}^{2 δ} ) {p}_{2} ( x - u , y - v ) ) \vert {H}_{2} ( u , v ) - {F}_{L , 2} ( u , v ) \vert dudv \leq 2 ϵ + ( {\int }_{0}^{2 δ} {\int }_{0}^{π} + {\int }_{0}^{π} {\int }_{0}^{2 δ} - {\int }_{0}^{2 δ} {\int }_{0}^{2 δ} ) {p}_{2} ( x - u , y - v ) ) \vert {H}_{2} ( u , v ) - {F}_{L , 2} ( u , v ) \vert dudv \leq 2 \text{} ϵ + ( {\int }_{0}^{2 δ} {\int }_{0}^{π} + {\int }_{0}^{π} {\int }_{0}^{2 δ} - {\int }_{0}^{2 δ} {\int }_{0}^{2 δ} ) \text{} {p}_{2} ( x - u , y - v ) \text{} dudv = 2 ϵ + ( {\int }_{x - 2 δ}^{x} {\int }_{y - π}^{y} + {\int }_{x - π}^{x} {\int }_{y - 2 δ}^{y} - {\int }_{x - 2 δ}^{x} {\int }_{y - 2 δ}^{y} ) \text{} {p}_{2} ( u , v ) dudv = 2 ϵ + {C}_{O , 2} ( x , y ) - {C}_{O , 2} ( x - 2 δ , y - 2 δ ) , \qquad ( 47 )$$

where the second step follows from Cauchy-Schwarz inequality, the third step follows from partitioning the integration region, the forth step follows from Eq. (45) and the fact that p(x, y) is supported in

$$[ - \frac{π}{3} , \frac{π}{3} ] \times [ - \frac{π}{3} , \frac{π}{3} ] and δ < \frac{π}{6}$$

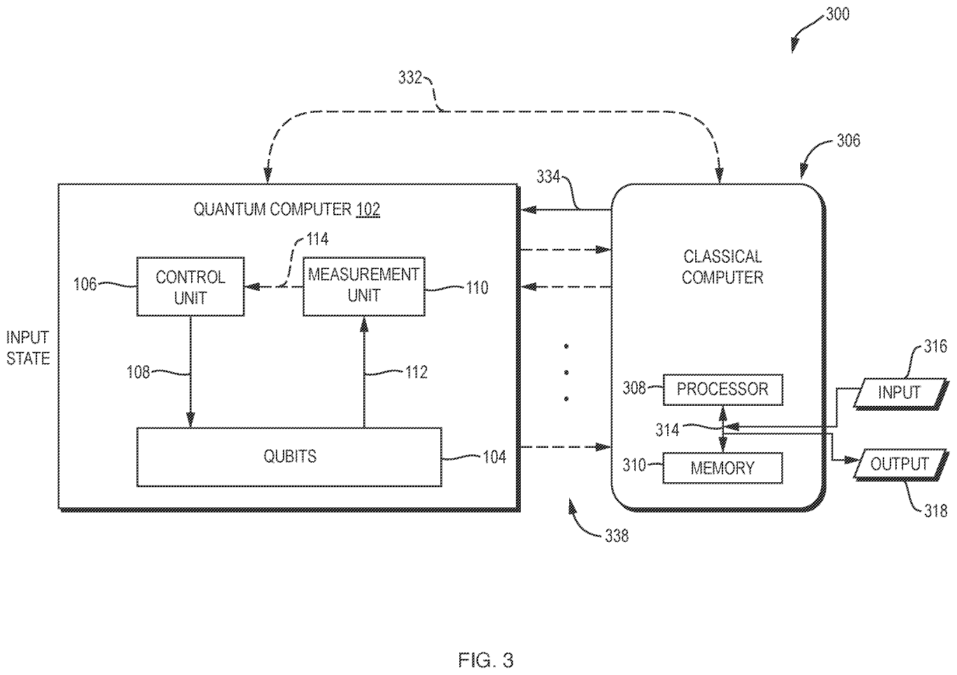

(see FIG. 3 (a)), the fifth step follows from p_{0,2}(x) is a density function, the last step follows from C_{0,2}(x) is the CDF of p_{0,2}(x) in [−π, π]×[−π, π] and

$$x , y ∈ [ - \frac{π}{3} , \frac{π}{3} ] .$$

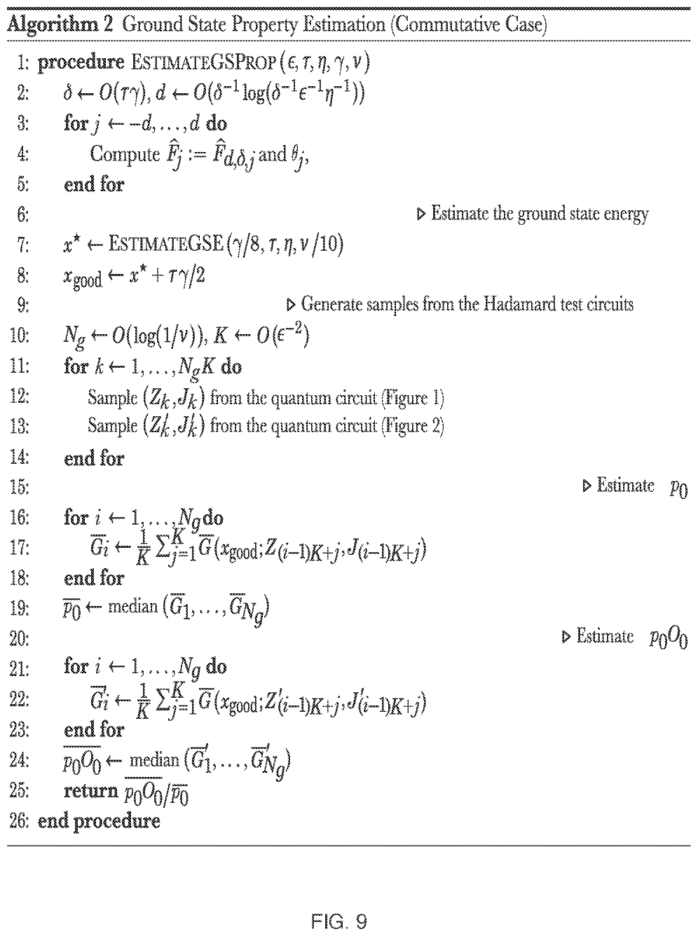

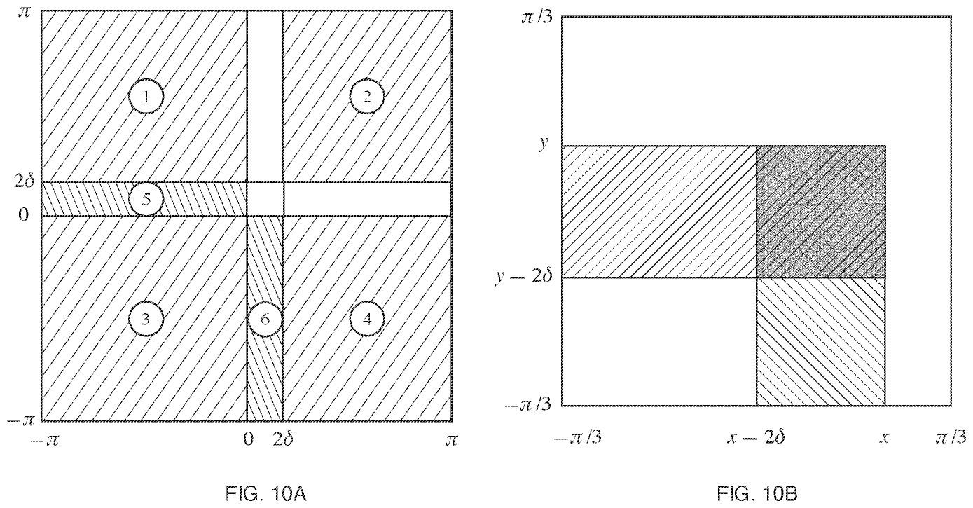

FIG. 10(a) shows the integral region for Equation 44, where the integral in regions 1-6 can be upper bounded by Equation 43. FIG. 10(b) shows the integral region for equation 45(a) is the integral region for Eq. (46), where the integral in regions 1-6 can be upper bounded by Eq. (45).

Hence, it follows that:

$$( x , y ) \geq {C}_{O , 2} ( x , y ) - ( 2 ϵ + {C}_{O , 2} ( x , y ) - {C}_{O , 2} ( x - 2 δ , y - 2 δ ) ) = {C}_{O , 2} ( x - 2 δ , y - 2 δ ) - 2 ϵ , \qquad ( 48 )$$

which proves the first inequality:

[symbol]

(x−δ,y−δ)≥C_{0,2}(x−2δ, y−2δ)−2ϵ. (49)

Similarly, it is defined that F_{R,2}:=F₂(x+δ, y+δ) and [symbol] (x, y):=(F_{R,2}*p₂)(x,y), and can be shown that

|C_{0,2}(x,y)− [symbol] (x,y)|≤2ϵ+C_{0,2}(x+2δ,y+2δ)−C_{0,2}(x,y) (50)

which gives

[symbol]

(x+δ,y+δ)≤C_{0,2}(x+2δ,y+2δ)+2ϵ. (51)

The lemma is then proved.

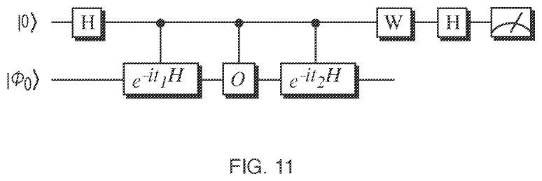

Estimating the 2-d ACDF. The parameterized quantum circuit, shown in FIG. 11, is used to estimate the 2-d O-weighted ACDF [symbol] (x, y). In FIG. 11, the quantum circuit is parameterized by t₁, t₂. H is the Hadamard gate and W is either I or a phase gate S.

Lemma 3. (Estimate 2-d O-weighted ACDF) For any x,y ∈[−π/3,π3], for any ϵ,v ∈(0,1), [symbol] (x, y) may be estimated with additive error ηϵ with probability 1−v by running the quantum circuit (FIG. 4) O(ϵ⁻²η⁻² log (1/v)) times with maximal evolution time Õ(γ⁻¹) and total expected evolution time Õ(γ⁻¹ϵ⁻¹η⁻¹).

Proof [symbol] (x, y) can be expanded in the following way:

$$\tilde{{C}_{O , 2}} ( x , y ) = ( {F}_{2} * {p}_{2} ) ( x , y ) = {\int }_{- π}^{π} {\int }_{- π}^{π} {F}_{2} ( x - u , y - v ) {p}_{2} ( u , v ) dudv = {\sum }_{\vert j \vert \leq d , \vert {j}^{′} \vert \leq d} {\int }_{- π}^{π} {\int }_{- π}^{π} \hat{{F}_{j}} {\hat{F}}_{{j}^{′}} {e}^{ij ( x - u )} {e}^{{ij}^{′} ( y - v )} {p}_{2} ( u , v ) dudv = {\sum }_{\vert j \vert \leq d , \vert {j}^{′} \vert \leq d} \hat{{F}_{j}} {\hat{F}}_{{j}^{′}} {e}^{i ( jx + {j}^{′} y )} {\int }_{- π}^{π} {\int }_{- π}^{π} {p}_{2} ( u , v ) {e}^{- i j u} {e}^{- i {j}^{′} v} dudv = {\sum }_{\vert j \vert \leq d , \vert {j}^{′} \vert \leq d} \hat{{F}_{j}} {\hat{F}}_{{j}^{′}} {e}^{i ( jx + {j}^{′} y )} {\sum }_{k , {k}^{′}} {c}_{k}^{*} {c}_{k} {O}_{k , {k}^{′}} {e}^{- i j τ {λ}_{k}} {e}^{- i {j}^{′} τ {λ}_{{k}^{′}}} = {\sum }_{\vert j \vert \leq d , \vert {j}^{′} \vert \leq d} \hat{{F}_{j}} {\hat{F}}_{{j}^{′}} {e}^{i ( jx + {j}^{′} y )} \cdot 〈 {ϕ}_{0} \vert {e}^{- i j τ H} {Oe}^{- i {j}^{′} τ H} \vert {ϕ}_{0} 〉 , \qquad ( 52 )$$

To estimate [symbol] ϕ₀|e^{-ijτH} Oe^{-ij′τH}|ϕ₀ [symbol] , the multi-level Monte Carlo method is used and define random variables J, J′ with support {−d, . . . , d} such that

$$P r [ J = j , {J}^{′} = {j}^{′} ] = \frac{\vert \hat{{F}_{j}} \vert \vert {\hat{F}}_{{j}^{′}} \vert}{{ℱ}^{2}} , \qquad ( 54 )$$

where [symbol] :=Σ_{|j|≤d}|\hat{F}ⱼ|. Then, let Z:=X_{j,j′}+iY_{j,j′}∈{±1+i}. Define an estimator G̅₂̅ (x;j,j′, Z) as follows:

G̅₂̅ (x,y; j,Z):= [symbol] ²⋅Ze^{i(θ}^{ⱼ}^{+jx)}e^{i(θ}^{_{j′}}^{+j′y)}, (55)

where θⱼ is defined by \hat{F}ⱼ=|\hat{F}ⱼ|e^{iθ}^{ⱼ}, and similar definition for θ_{j′}. Then, it is shown that G̅₂̅ (x, y; j, Z) is un-biased:

$$E [ \overline{{G}_{2}} ( x , y ; J , {J}^{′} , Z ) ] = {\sum }_{\vert j \vert \leq d , \vert {j}^{′} \vert \leq d} E [ ( {X}_{j , {j}^{′}} + {iY}_{j , {j}^{′}} ) {e}^{i ( {θ}_{j} + j x )} {e}^{i ( {{θ}_{j}}^{′} + {j}^{′} y )} \vert \hat{{F}_{j}} \vert \vert {\hat{F}}_{{j}^{′}} \vert ] = {\sum }_{\vert j \vert \leq d , \vert {j}^{′} \vert \leq d} \hat{{F}_{j}} {\hat{F}}_{{j}^{′}} {e}^{i j x} {e}^{i {j}^{′} y} \cdot E [ {X}_{j , {j}^{′}} + i {Y}_{j , {j}^{′}} ] = {\sum }_{\vert j \vert \leq d , \vert {j}^{′} \vert \leq d} \hat{{F}_{j}} {\hat{F}}_{{j}^{′}} {e}^{i j x} {e}^{i {j}^{′} y} \cdot 〈 {ϕ}_{0} \vert {e}^{- i j τ H} {Oe}^{- i {j}^{′} τ H} \vert {ϕ}_{0} 〉 \qquad ( 56 )$$

$$= ( x , y ) , \qquad ( 57 )$$

where the third step follows from claim 1. Moreover, the variance of G̅₂̅ can be upper-bounded by:

$$Var [ \overline{{G}_{2}} ( x , y ; J , {J}^{′} , Z ) ] = E [ {\vert \overline{{G}_{2}} ( x , y ; J , {J}^{′} , Z ) \vert}^{2} ] - {\vert E [ \overline{{G}_{2}} ( x , y ; J , {J}^{′} , Z ) ] \vert}^{2} \leq E [ {\vert \overline{{G}_{2}} ( x , y ; J , {J}^{′} , Z ) \vert}^{2} ] = {ℱ}^{4} \cdot E [ {\vert {X}_{J , {J}^{′}} + {iY}_{J , {J}^{′}} \vert}^{2} ] \qquad ( 58 )$$

$$= 2 {ℱ}^{4} , \qquad ( 59 )$$

where the third step follows from |e^{i(θ}^{ⱼ}^{+jx)}|=|e^{i(θ}^{_{j′}}^{+j′y)}|=1, and the last step follows from X_{j,j′}, Y_{j,j′}∈{±1}.

By Lemma 8, it is known that [symbol] =Õ(1). Hence, it follows for all x, y ∈[−π/3,π/3],

E[G̅₂̅ (x, y)]= [symbol] (x, y), and Var [G̅₂̅ (x, y)]=Ō(1). (60)

Then, using median-of-means estimator, an E-additive error estimate may be obtained of [symbol] (x, y) with probability 1−v using O(ϵ⁻²η⁻² log (1/v)) samples. The maximal evolution time is 2d=Õ(γ⁻¹). And the expected evolution time for one trial is

$$τ {\sum }_{\vert j \vert , \vert {j}^{′} \vert \leq d} ( j + {j}^{′} ) \frac{\vert \hat{{F}_{j}} \vert \vert {\hat{F}}_{{j}^{′}} \vert}{{ℱ}^{2}} = 2 τ {\sum }_{\vert j \vert \leq d} j \frac{\vert \hat{{F}_{j}} \vert}{ℱ} = O ( τ d / log ( d ) ) . \qquad ( 61 )$$

Hence, the total expected evolution time is Õ(γ⁻¹ϵ⁻²η⁻²). The lemma is then proved.

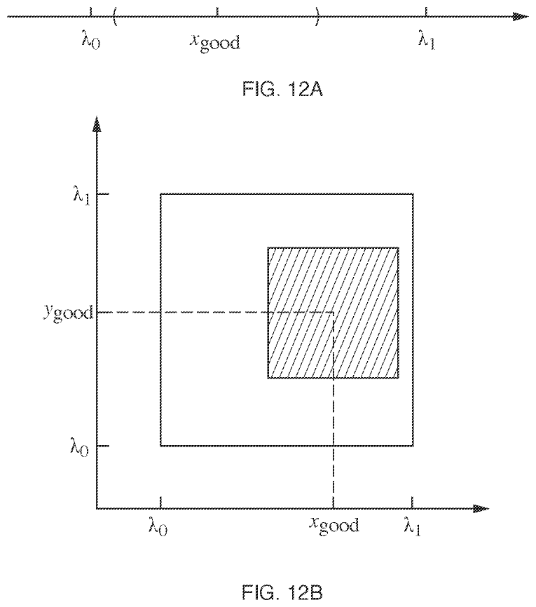

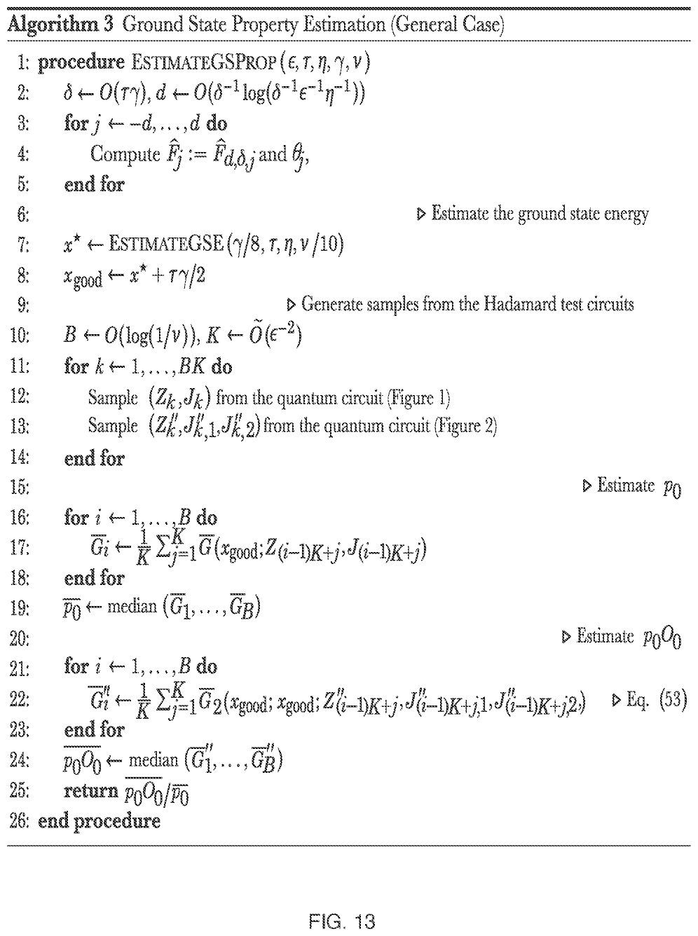

FIG. 12(a) shows a point that is good for λ₀, where the interval enclosed by parentheses is the approximation region such that [symbol] (x_{good}) is close to C(x) for some x in this interval. FIG. 12(b) shows a good point in the 2-d case, wherein the larger square, the 2-d O-weighted CDF C_{0,2} takes the same value C_{0,2}(λ₀,λ_{O}). The smaller square with hatching defines the approximation region of (x_{good}, y_{good}) such that [symbol] (x_{good}, y_{fgood}) is close to some C_{0,2}(x, y) in this region. Similar to the 1-d case, a “good” point for (λ₀,λ₀) may be constructed via the following claim.

Claim 4. Construct 2-d good point Let y be the spectral gap of the Hamiltonian H. Let x_{good}:=x*+τγ/2 where x* is the output of EstimateGSE(γ/8, τ, η, v/10) (Algorithm 1). Then, (x_{good}, x_{mathsfgood}) is good for (λ₀,λ₀). In particular, for any ϵ∈(0,1), if the approximation error of F(x) is set to be ϵη, then

[symbol]

(x_{good},x_{good})−C_{0,2}(λ_{0,2},λ₀)|≤2ϵη. (62)

Proof By claim 1, it is known that X_{good} is good for λ₀, i.e., [x_{good}−δ, x_{good}+δ] is contained in [λ₀,λ₁). It also holds in the 2-d case for (x_{good}, x_{good}). Then, by Lemma 3:

$${C}_{O , 2} ( {x}_{g o o d} - δ , {x}_{g o o d} - δ ) - 2 ϵη \leq ( {x}_{g ood} , {x}_{g o o d} ) \leq {C}_{O , 2} ( {x}_{g o o d} + δ , {x}_{g o o d} + δ ) + 2 ϵη . \qquad ( 63 )$$

The claim then follows from C_{0,2}(x, y)=C_{0,2}(λ₀,λ₀) for any (x, y) ∈[λ₀,λ₁)×[λ₀,λ₁).

Ground State Property Estimation (General Case)

The main algorithm for the ground state property estimation will first estimate the ground state energy λ₀ and the overlap l₀. Then, by Lemma 3 and claim 4, the weighted expectation p₀O₀ may also be estimated. Hence, an estimate for O₀= [symbol] ψ₀|O|ψ₀ [symbol] is obtained.

FIG. 13 illustrates the algorithm for ground state property estimation (general case) for Algorithm 3 in pseudocode.

Proof of Theorem 1. The estimation error of Algorithm 3 is first analyzed. By Lemma 2, p̅₀̅ has additive error at most O (ηϵ). By Lemma 3 and claim 4, p̅₀̅O̅₀̅ has additive error at most O(ηϵ). Then, a similar error propagation analysis in Theorem 7 yields

$$\vert \overline{\frac{{p}_{0} {O}_{0}}{\overline{{p}_{0}}}} - {O}_{0} \vert \leq O ( ϵ ) . \qquad ( 64 )$$

To maximize probability of success, Algorithm 3 has three components: estimate ground state energy, estimate p₀, and estimate p₀O₀. Using this choice of parameters, each of them will fail with probability at most v/3. Hence, Algorithm 3 will succeed with probability at least 1−v. The maximal evolution time and the total expected evolution time follows from Theorem 1, Lemma 2, and Lemma 3.

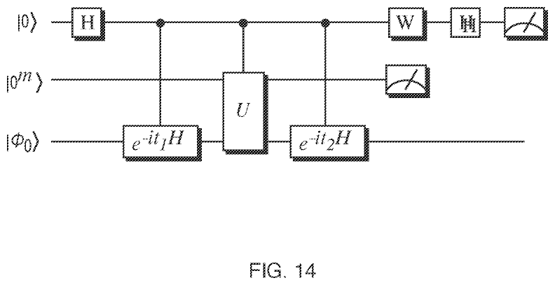

Handling Non-Unitary Observables. Algorithm 3 works only for unitary observables because it needs to use the parameterized quantum circuit in FIG. 14 to estimate [symbol] ϕ₀|e^{-it}^{₂}^{H}Oe^{-it}^{₁}^{H}|ϕ₀ [symbol] for certain t₁, t₂ ∈ [symbol] , in which controlled-O must be a unitary operation. In this section, it is shown that under reasonable assumptions the disclosed algorithm can be modified to estimate the ground state property [symbol] ψ₀|O|ψ₀ [symbol] where 0 is a general observable.

There may be a question as to why this method is necessary, since O may be decomposed into a linear combination of Pauli strings O=Σ_{\vec{s}}w_{\vec{s}}P_{\vec{s}}, and Algorithm 3 used to estimate each term μ [symbol] ψ₀|P_{\vec{s}}|ψ₀ [symbol] individually, and return Σ_{\vec{s}}μ_{\vec{s}} as the result. While this strategy works in principle, it may lack the efficiency to be practical, depending ending on the weights w_{\vec{s}}'s of Pauli strings in the linear expansion of O.

Alternatively, the issue of Algorithm 3 may be fixed by designing a procedure for estimating [symbol] ϕ₀|e^{-it}^{₂}^{H}Oe^{-it}^{₁}^{H}|ϕ₀ [symbol] for arbitrary non-unitary O. Such quantities are utilized in the same way as before. This approach has been followed and found that it is possible when there is a block-encoding of O. Namely, suppose O is an n-qubit observable with ∥O∥≤1 and U is an (n+m)-qubit unitary operator such that

( [symbol] 0^{m}|⊗I)U(|0^{m} [symbol] ⊗I)=α⁻¹O (65)

for some α≥∥O∥. Then a Hadamard test for U may be performed to estimate [symbol] ϕₒ|e^{-it} ^{₂}^{H}Oe^{-it}^{₁}^{H}|ϕ₀) [symbol] for arbitrary t₁, t₂ ∈ [symbol] . The main theorem of this section is stated below:

Theorem 1. Ground state property estimation with block-encoded observable. Suppose p₀≥η for some known η and the spectral gap of the Hamiltonian H is at least γ. Assuming an access to the α-block-encoding of the observable O. For any ϵ,v ∈ (0,1), there exists an algorithm for estimating the ground state property [symbol] ψ₀O|ψ₀ [symbol] within additive error at most ϵ with probability at least 1−v, such that:
1. the expected total evolution time is Õ(γ⁻¹ϵ⁻²η⁻²α²),,
2. the maximal evolution time is Õ(γ⁻¹).

Proof sketch of Theorem 1. The algorithm for handling non-unitary block-encoded observables is quite similar to Algorithm 5.3 for handling unitary observables, except that it relies on a different procedure to estimate [symbol] ϕ₀|e^{-it}^{₂}^{H}Oe^{-it}^{₁}^{H}|ϕ₀ [symbol] for arbitrary t₁, t₂ ∈ [symbol] . The procedure is described as follows:

Let C−V:=|0 [symbol] 0|⊗I+|1 [symbol] 1|⊗V be the controlled-V operation for arbitrary unitary operator V. Let |ϕ₀) be an arbitrary n-qubit state.

Consider the following procedure as illustrated in FIG. 15. Quantum circuit parameterized by t₁, t₂. H is the Hadamard gate and W is either I or a phase gate S. U is the block-encoding of the non-unitary observable O.
1. Prepare the state |0 [symbol] |0^{m} [symbol] |ϕ₀ [symbol] .
2. Apply a Hadamard gate on the first register.
3. Apply a C-e^{-iHt}^{₁} on the first and third registers.
4. Apply C-U on the current state, obtaining

$$\frac{1}{\sqrt{2}} ( \vert 0 〉 \vert {0}^{m} 〉 \vert {ϕ}_{0} 〉 + \vert 1 〉 U \vert {0}^{m} 〉 {e}^{- i H {t}_{1}} \vert {ϕ}_{0} 〉 ) . \qquad ( 66 )$$

5.
6. Measure the second register in the standard basis. If the outcome is not 0^{m}, then this procedure fails; otherwise, continue. The probability of this step succeeding is

$${p}_{succ} = \frac{1 + {α}^{- 2} 〈 {ϕ}_{0} \vert {e}^{i H {t}_{1}} {O}^{2} {e}^{- i H {t}_{1}} \vert {ϕ}_{0} 〉}{2} , \qquad ( 67 )$$

7. and when this event happens, the state becomes

$$\frac{1}{\sqrt{2 {p}_{s u c c}}} [ \vert 0 〉 \vert {ϕ}_{0} 〉 + {α}^{- 1} \vert 1 〉 {O e}^{- i H {t}_{1}} \vert {ϕ}_{0} 〉 ] . \qquad ( 68 )$$

8.
9. Apply a C-e^{--iHt}^{₂} on the first and third registers. The state becomes

$$\frac{1}{\sqrt{2 {p}_{s u c c}}} [ \vert 0 〉 \vert {ϕ}_{0} 〉 + {α}^{- 1} \vert 1 〉 {e}^{- i H {t}_{2}} O {e}^{- {iHt}_{1}} \vert {ϕ}_{0} 〉 ] . \qquad ( 69 )$$

10.
11. Apply W=I or phase gate S on the first register.
12. Apply a Hadamard gate on the first register.
13. Measure the first register in the standard basis. Then if W=I, the (conditional) probability of getting outcome 0 is

$$ℙ [ 0 \vert succ ] = \frac{{p}_{s u c c} + {α}^{- 1} Re [ 〈 {ϕ}_{0} \vert {e}^{- i H {t}_{2}} O {e}^{- i H {t}_{1}} \vert {ϕ}_{0} 〉 ]}{2 {p}_{s u c c}} ; \qquad ( 70 )$$

14. if W=S, this probability is
15.

$$ℙ [ 0 \vert succ ] = \frac{{p}_{s u c c} - {α}^{- 1} Im [ 〈 {ϕ}_{0} \vert {e}^{- i H {t}_{2}} O {e}^{- i H {t}_{1}} \vert {ϕ}_{0} 〉 ]}{2 {p}_{s u c c}} . \qquad ( 71 )$$

Two random variables X and Y are defined as follows. First, the above procedure is run with W=I in step 7. If step 5 fails, X=0; otherwise, if the measurement outcome is 0 or 1 in step 9, then X=α or −α, respectively. One can show that X is an unbiased estimator of Re [ [symbol] ϕ₀|e^{-iEt}^{₂}Oe^{-iHt}^{₁}|ϕ₀ [symbol] ], i.e.

[symbol]

[X]=Re [ [symbol] ϕ₀|e^{-iHT}^{₂}Oe^{-iHt}^{₁}|ϕ₀ [symbol] ]. (72)

Y is defined similarly. The above procedure is run with W=S in step 7. If step 5 fails, Y=0; otherwise, if the measurement outcome is 1 or 0 in step 9, then Y=α or −α, respectively. Then Y is an unbiased estimator of Im [ [symbol] ϕ₀e^{-iHt}^{₂}Oe^{-iHt}^{₁}|ϕ₀ [symbol] ], i.e.

[symbol]

[Y]=Im[ [symbol] ϕ₀|e^{-iHT}^{₂}Oe^{-iHt}^{₁}|ϕ₀ [symbol] ]. (73)

It follows that Z:=X+iY is an unbiased estimator of [symbol] ϕ₀|e^{-iHt}^{₂}Oe^{-iHt}^{₁}|ϕ₀ [symbol] ,i.e.

[symbol]

[Z]= [symbol] ϕ₀|e^{-iHt}^{₂}Oe^{-iHt}₁|ϕ₀ [symbol] . (74)

Note that |Z|²=|X|²+|Y|²≤2a² with certainty.

Equipped with the above method for estimating [symbol] ϕ₀|e^{-iHt}^{₂}Oe^{-iHt}^{₁}|ϕ₀ [symbol] for arbitrary t₁, t₂ ∈ [symbol] , the same strategy can be used as in Lemma 3 to estimate [symbol] (x, y). The other components of Algorithm 3 remain intact. The analysis of this modified algorithm is almost the same as before, except now:

Var|G̅₂̅ (x,y)|=\tilde{O}(α²). 75)

As a consequence, compared to Theorem 1, the total evolution time of this modified algorithm is larger by a factor of O (a²), while its maximal evolution time is of the same order. W

### Applications

In this section, example applications of the disclosed ground state property estimation algorithm are discussed. To define an application of the ground state property estimation algorithm, a Hamiltonian of interest H and an observable of interest O must be specified. An example application used in quantum chemistry and materials is the Green's function, where O=αᵢ(z-(H−E₀)⁻¹)αⱼ^{†}.

The following two sections are from the fields of quantum chemistry and materials as well as an example of a linear algebraic subroutine.

Charge density. The primary application of the technique is the estimation of ground state properties of physical systems. The following describes how to compute the charge density of a molecule, which can be used to compute properties like electric dipole moments of a molecule. From a second-quantized representation of the electronic system (assuming fixed positions of the nuclear positions), the charge density is determined from the one-particle reduced density matrix as,

$$ρ ( \vec{r} ) = - e {\sum }_{p , q} {D}_{p , q} {ϕ}_{p} ( \vec{r} ) {ϕ}_{q} ( \vec{r} ) , \qquad ( 76 )$$

where e is the electric constant, D_{pq} is the one-electron reduced density matrix (1RDM) of the ground state, and ϕ_{q}(\vec{τ}) are the basis wave functions chosen for the second-quantized representation of the electronic system. The 1RDM of the ground state is a matrix of properties of the ground state with each entry defined as

D_{p,q}= [symbol] ψ₀|αₚ^{†}α_{q}|ψ₀ [symbol] , (77)

where αₚ are annihilation operators. The operators involved in the 1RDM can each be expressed as a linear combination of unitary operators using the Majorana representation αₚ=½(γ₂ₚ+iγ₂ₚ₊₁), where the γₖ are hermitian and unitary,

D_{p,q}=¼ ( [symbol] ψ₀|γ₂ₚγ_{2q}|ψ₀ [symbol] -i [symbol] ψ₀|γ₂ₚ₊₁γ_{2q}|ψ₀ [symbol] +i [symbol] ψ₀|γ₂ₚγ_{2q+1}^{|ψ}₀ [symbol] + [symbol] ψ₀|γ₂ₚ₊₁γ_{2q+1}|ψ₀ [symbol] ). (78)

Accordingly, the prior method may be used to estimate each entry of the 1RDM and then obtain the charge density function of the ground state. As a point of comparison, alternatively, the variational quantum eigensolver algorithm is used to prepare an approximation to the ground state and then directly estimate each of the Pauli expectation values. However, there is no guarantee on whether a target accuracy for the ground state approximation can be achieved. The disclosed methods may be used to ensure a target accuracy in the estimation regardless of the quality of ground state approximation, though possibly at the cost of an increase in runtime.

Quantum Linear System Solver. A quantum algorithm is proposed to generate a quantum state approximately proportional to the solution of a linear system of equations. Namely, given a linear system A\vec{x}=\vec{b}, the algorithm produces a quantum state close to

$$\vert x 〉 := \frac{{Σ}_{j} {x}_{j} \vert j 〉}{\sqrt{{Σ}_{j} {\vert {x}_{j} \vert}^{2}}} ,$$

where xⱼ's are the entries of \vec{x}=A⁻¹\vec{b}. In fact, in many cases, it is only necessary to know (x|M|x), where M is a linear operator. For example, in quantum mechanics, many features of |x [symbol] can be extracted in this way, including normalization, moments, etc. One approach to solve this problem is first solving the linear system using any quantum linear system solver to obtain the state Ix) and then performing the measurement of M. However, a shortcoming of this method is that most of the quantum linear system solvers require deep quantum circuits. And hence, the needed quantum resources may not be accessible in the near future.

Recently, a few quantum algorithms were developed to solve linear systems of equations by encoding such a system into an effective Hamiltonian

H_{G}:=A^{†}(I−|b [symbol] b|)A, (79)

whose ground state corresponds to the solution vector ⊕x [symbol] . This idea can be combined with the disclosed ground state property estimation algorithm to get a low-depth algorithm for estimating the properties of linear system solution. More specifically, suppose the Hamiltonian H_{G} can be simulated for some specified time and the normalization factor τ is known such that the eigenvalues of τH_{G} are in [−π/3,π/3]. For the operator M, assume that M can be decomposed into a linear combination of Pauli operators M= [symbol] , or assume that M is given in the block-encoding form. The estimation algorithm has two steps:
1. Run a quantum linear system algorithm with constant precision to prepare an initial state |ϕ₀) such that [symbol] ϕ₀|x [symbol] |² is Ω(1).
2. Using |ϕ₀ [symbol] C)) from step 1 as the initial state, run Algorithm 3 to estimate [symbol] x|M|x [symbol] within ϵ-additive error for any ϵ∈(0,1).

Step 1 takes Õ(κ) time, where κ is the condition number of A. To analyze the computation cost of the second step, a lower-bound on the spectral gap of H_{G} is needed. Since [symbol] x|A^{†}(I−|b [symbol] b|)A|x [symbol] =0, the results in λ₀(H_{G})=0. For the second smallest eigenvalue, since H_{G}=A^{†}A−A^{e}τ|b [symbol] b|A, by Weyl's inequality, ga(κ⁻²).

$${λ}_{1} ( {H}_{G} ) \geq {λ}_{0} ( {A}^{†} A ) - {λ}_{1} ( {A}^{†} \vert b b \vert A ) = {λ}_{0} ( {A}^{†} A ) , \qquad ( 80 )$$

where the second step follows from A^{†}|b [symbol] b|A is rank−1. Due to the normalization, the smallest (normalized) singular value of A is Ω(κ⁻¹). Hence, γ=Ω(κ⁻²). By Theorem 1, the maximal evolution time of the Hamiltonian will be Õ(κ²). To further improve the circuit depth, the gap amplification technique may be applied to quadratically increase the spectral gap of H_{G}. Specifically, consider the following family of Hamiltonians:

\vec{H}′_{G}(s):=σ⁺⊗Ā^{†}(s)(I−|b̅ [symbol] b̅|)+σ⁻⊗(I−|b̅ [symbol] b̅|)Ā(s), (81)

where 94 ^{±}=(X±iY)/2, Ā(s):=(1−s)Z⊗I+sX⊗A, |b̅ [symbol] :=|+ [symbol] |b̅ [symbol] : and s ∈[0,1]. Note that these Hamiltonians act on the original system and two ancilla qubits. Then:

$${( {{H}^{–}}_{G}^{′} ( s ) )}^{2} = [ \begin{matrix}{{H}^{–}}_{G} ( s ) & 0 ( 82 ) \\ 0 & ( I - \vert \overline{b} \overline{b} \vert ) \overline{A} ( s ) {\overline{A}}^{†} ( s ) ( I - \vert \overline{b} \overline{b} \vert )\end{matrix} ] , \qquad ( 83 )$$

$${\overline{H}}_{G} ( s ) := {\overline{A}}^{†} ( s ) ( I - \vert \overline{b} \overline{b} \vert ) \overline{A} ( s ) . \qquad ( 84 )$$

As shown, the eigenvalues of Ĥ′_{G}(s) are

{0,0,±{square root over (λ₁)s),)} ±\sqrt{λ₂(s),}. . . }, (85)

where λⱼ(s)'s are the nonzero eigenvalues of Ĥ_{G}(s). Furthermore, let |x(s) [symbol] be the unique ground state of Ĥ_{G} (S) . Note that |x(0) [symbol] =|- [symbol] |b [symbol] and |x(1) [symbol] =|+ [symbol] |x [symbol] .)1x). Then the ground space of Ĥ′_{G} (s) is spanned by {|0 [symbol] |x(s) [symbol] , |1 [symbol] |b̅ [symbol] }. In addition, for s=1, one can use Weyl's ineqality to show that λ₁ (1)≥κ⁻², which implies that the smallest nonzero eigenvalue of H̅_{G}′ (1) is (1) is Ω(κ⁻¹), as desired.

The disclosed algorithm used to prepare a state that has Ω(1) overlap with |0 [symbol] |x(1) [symbol] =|0 [symbol] |+ [symbol] |x [symbol] in Õ(κ) time. Specifically, this algorithm starts with the state |0 [symbol] |x(0) [symbol] =|(0 [symbol] | [symbol] |b [symbol] , performs a sequence of unitary operations of form e^{-it}^{ₖ}^{H̅}^{_{G}}^{′(s}^{ₖ}⁾ on it, and outputs a state ϵ-close to |0)|x(1)) in Õ(κϵ⁻¹) time. Here, ϵ=Θ(1) is set, and the time cost of this procedure is Õ(κ). After obtaining a state |ϕ₀ [symbol] that has Ω(1) overlap with |0 [symbol] |+ [symbol] |x [symbol] , Algorithm 3 may be run on |ϕ₀ [symbol] , H̅′_{G}(1) and \tilde{M}:=|0 [symbol] 0|⊗|+ [symbol] +|⊗M to estimate [symbol] 0+, x|\tilde{M}|0,+,x [symbol] =|M| [symbol] .

Since the ground state energy of H̅′_{G}(1) is zero, it is not needed to first estimate the ground state energy using Algorithm 1. Instead, direct evaluation may be used with O-weighted CDF at zero. Therefore, by Theorem 1, the following result is obtained.

Corollary 1. (Quantum linear system solution property estimation). For a linear system A\vec{x}=\vec{b}, suppose A has singular values in [−1, −1/κ] ∪[1/κ,1] for κ>1, and the eigenvalues of H̅′_{G}(1) (Eq. (81)) are in [−π/3,π3]. Furthermore, it is possible to implement e^{--itH̅′}^{_{G}}^{(s)} (Eq. (81)) in Õ(t) time for all s∈[0,1].

Then, for any linear operator M given by its a-block encoding unitary U_{M}, and for any ϵ∈(0,1), the expectation value [symbol] x|M|x [symbol] can be estimated with ϵ-additive error with high probability such that:
the depth of each circuit is Õ(κ)
the expected total runtime is Õ(κϵ⁻²α²).

For comparison, the algorithm in needs Õ(κϵ⁻¹) circuit depth to obtain a state that is ϵ-close to |x [symbol] , which is larger than that of the disclosed algorithm. Moreover, to estimate [symbol] x|M|x [symbol] , even with amplitude estimation, it still needs Ω(ϵ⁻¹) copies of the state to achieve E-additive error. Hence, its total runtime will be Õ(κϵ⁻²), nearly matching the result of the disclosed algorithm (ignoring the dependence on the α factor).

A quantum-classical hybrid algorithm has been disclosed for estimating properties of the ground state of a Hamiltonian, such that the quantum circuit depth is relatively small and only poly-logarithmically depends on ϵ⁻¹. Therefore, the algorithm has a significant advantage in high-accuracy estimation, and it is possible to be implemented in early fault-tolerant devices. In practice, the disclosed algorithm can solve many important tasks by combining with some initial state preparation methods (e.g., VQE or QAOA). Current applications include quantum chemistry and solving linear systems. More applications will be explored in the future.

Another important direction is to improve the total evolution time of the disclosed algorithm which quadratically depends on ϵ⁻¹. The blowup comes from evaluating the O-weighted CDF in high precision and a trade-off between maximal evolution time and total evolution time. However, this does not meet the Heisenberg-limit of linear dependence on ϵ⁻¹ for generic Hamiltonians. In the main result (Theorem 1), the ϵ⁻²η⁻² factor comes from the number of samples needed to reduce the estimator's error to O (ϵη). Amplitude estimation can be used to reduce this number of samples and the total evolution time. However, this comes at the cost of significantly increasing the maximal evolution time, which could require large fault-tolerant overheads for reliable implementation.

If λ characterizes the fidelity decay rate of the circuit as deeper circuits are used, then it would be expected to require a maximal evolution time of O(ξ⁻¹γ⁻¹) and a total evolution time of O(λγ⁻¹ϵ⁻²η⁻²). Note that because this approach incorporates the impact of error into the algorithm, the maximal evolution time is of no concern. Rather than being a cost that needs monitoring, the maximal evolution time is chosen by the algorithm to minimize the total evolution time. As the quality of devices improves, the performance of the algorithm improves proportionally. A similar approach can also be applied to improve the total evolution time in from Õ(ϵ⁻¹η⁻²) to Õ(λϵ⁻¹η⁻²).

In some embodiments, the techniques described herein relate to a method for estimating a ground state property of an observable (O), performed on a hybrid quantum-classical computer, the computer including a quantum computing component having a plurality of qubits, and a classical computing component including at least one processor and a non-transitory computer-readable memory, the non-transitory computer-readable memory storing computer instructions, which, when executed by the classical processor, perform the method, the method including: initializing the quantum component to an initial state with qubit registers; estimating the ground state energy of a Hamiltonian (H) matrix that characterizes a physical system; generating a plurality of samples from a parameterized Hadamard test circuit; evaluating the sample outcomes; estimating the expectation value ( ) of the observable (O) with respect to the ground state energy; estimating the weighted expectation value ; and from the weighted expectation value, deriving an estimate of the ground state property.

Initializing the quantum component to the initial state may include initializing the quantum component to the initial state with the qubit registers and a single ancilla qubit.

The method may further include computing Green's functions using the ground state property. Computing Green's functions may include computing Green's functions to compute electron transport in materials. Computing Green's functions may include computing Green's functions to compute electric dipoles of molecules.

The physical system may include a molecule. The method may further include computing the charge density of the molecule. Computing the charge density of the molecule may include computing the charge density of the molecule from the one-particle reduced density matrix.

The physical system may include a material.

Deriving the estimate of the ground state property may include deriving the estimate of the ground state property using a low-depth quantum circuit with reduced error rates. The quantum circuit depth of the low-depth quantum circuit may be linear in the inverse spectral gap and poly-logarithmic in the inverse target accuracy and inverse initial overlap.

The method may further include using the using the ground state property to generate a quantum state approximately proportional to a solution of a linear system of equations.

Initializing the quantum component to the initial state may includes executing a variational quantum eigensolver (VQE). Initializing the quantum component to the initial state includes executing a quantum approximate optimization algorithm (QAQO).

In some embodiments, the techniques described herein relate to a quantum-classical algorithm for estimating a ground state property of an observable (0), wherein the algorithm (1) estimates ground state energy, (2) estimates the expectation value of the observable (O) with respect to the ground state, and (3) estimates the weighted expectation values.

In some embodiments, the techniques described herein relate to a system for estimating a ground state property of an observable (O), the system including a hybrid quantum-classical computer (HQC), the HQC computer including a quantum computing component having a plurality of qubits and a classical computing component including at least one processor and a non-transitory computer-readable memory, the non-transitory computer-readable memory storing computer instructions, which, when executed by the classical processor, perform a method for estimating the ground state property of the observable (O), the method, including: initializing the quantum component to an initial state with qubit registers; estimating the ground state energy of a Hamiltonian (H) matrix that characterizes a physical system; generating a plurality of samples from a parameterized Hadamard test circuit; evaluating the sample outcomes; estimating the expectation value ( ) of the observable (O) with respect to the ground state energy; estimating the weighted expectation value ; and from the weighted expectation value, deriving an estimate of the ground state property

It is to be understood that although the invention has been described above in terms of particular embodiments, the foregoing embodiments are provided as illustrative only, and do not limit or define the scope of the invention. Various other embodiments, including but not limited to the following, are also within the scope of the claims. For example, elements and components described herein may be further divided into additional components or joined together to form fewer components for performing the same functions.

Various physical embodiments of a quantum computer are suitable for use according to the present disclosure. In general, the fundamental data storage unit in quantum computing is the quantum bit, or qubit. The qubit is a quantum-computing analog of a classical digital computer system bit. A classical bit is considered to occupy, at any given point in time, one of two possible states corresponding to the binary digits (bits) 0 or 1. By contrast, a qubit is implemented in hardware by a physical medium with quantum-mechanical characteristics. Such a medium, which physically instantiates a qubit, may be referred to herein as a “physical instantiation of a qubit,” a “physical embodiment of a qubit,” a “medium embodying a qubit,” or similar terms, or simply as a “qubit,” for ease of explanation. It should be understood, therefore, that references herein to “qubits” within descriptions of embodiments of the present invention refer to physical media which embody qubits.

Each qubit has an infinite number of different potential quantum-mechanical states. When the state of a qubit is physically measured, the measurement produces one of two different basis states resolved from the state of the qubit. Thus, a single qubit can represent a one, a zero, or any quantum superposition of those two qubit states; a pair of qubits can be in any quantum superposition of 4 orthogonal basis states; and three qubits can be in any superposition of 8 orthogonal basis states. The function that defines the quantum-mechanical states of a qubit is known as its wavefunction. The wavefunction also specifies the probability distribution of outcomes for a given measurement. A qubit, which has a quantum state of dimension two (i.e., has two orthogonal basis states), may be generalized to a d-dimensional “qudit,” where d may be any integral value, such as 2, 3, 4, or higher. In the general case of a qudit, measurement of the qudit produces one of d different basis states resolved from the state of the qudit. Any reference herein to a qubit should be understood to refer more generally to an d-dimensional qudit with any value of d.

Although certain descriptions of qubits herein may describe such qubits in terms of their mathematical properties, each such qubit may be implemented in a physical medium in any of a variety of different ways. Examples of such physical media include superconducting material, trapped ions, photons, optical cavities, individual electrons trapped within quantum dots, point defects in solids (e.g., phosphorus donors in silicon or nitrogen-vacancy centers in diamond), molecules (e.g., alanine, vanadium complexes), or aggregations of any of the foregoing that exhibit qubit behavior, that is, comprising quantum states and transitions therebetween that can be controllably induced or detected.

For any given medium that implements a qubit, any of a variety of properties of that medium may be chosen to implement the qubit. For example, if electrons are chosen to implement qubits, then the x component of its spin degree of freedom may be chosen as the property of such electrons to represent the states of such qubits. Alternatively, the y component, or the z component of the spin degree of freedom may be chosen as the property of such electrons to represent the state of such qubits. This is merely a specific example of the general feature that for any physical medium that is chosen to implement qubits, there may be multiple physical degrees of freedom (e.g., the x, y, and z components in the electron spin example) that may be chosen to represent 0 and 1. For any particular degree of freedom, the physical medium may controllably be put in a state of superposition, and measurements may then be taken in the chosen degree of freedom to obtain readouts of qubit values.

Certain implementations of quantum computers, referred to as gate model quantum computers, comprise quantum gates. In contrast to classical gates, there is an infinite number of possible single-qubit quantum gates that change the state vector of a qubit. Changing the state of a qubit state vector typically is referred to as a single-qubit rotation, and may also be referred to herein as a state change or a single-qubit quantum-gate operation. A rotation, state change, or single-qubit quantum-gate operation may be represented mathematically by a unitary 2X2 matrix with complex elements. A rotation corresponds to a rotation of a qubit state within its Hilbert space, which may be conceptualized as a rotation of the Bloch sphere. (As is well-known to those having ordinary skill in the art, the Bloch sphere is a geometrical representation of the space of pure states of a qubit.) Multi-qubit gates alter the quantum state of a set of qubits. For example, two-qubit gates rotate the state of two qubits as a rotation in the four-dimensional Hilbert space of the two qubits. (As is well-known to those having ordinary skill in the art, a Hilbert space is an abstract vector space possessing the structure of an inner product that allows length and angle to be measured. Furthermore, Hilbert spaces are complete: there are enough limits in the space to allow the techniques of calculus to be used.)

A quantum circuit may be specified as a sequence of quantum gates. As described in more detail below, the term “quantum gate,” as used herein, refers to the application of a gate control signal (defined below) to one or more qubits to cause those qubits to undergo certain physical transformations and thereby to implement a logical gate operation. To conceptualize a quantum circuit, the matrices corresponding to the component quantum gates may be multiplied together in the order specified by the gate sequence to produce a 2″X2″ complex matrix representing the same overall state change on n qubits. A quantum circuit may thus be expressed as a single resultant operator. However, designing a quantum circuit in terms of constituent gates allows the design to conform to a standard set of gates, and thus enable greater ease of deployment. A quantum circuit thus corresponds to a design for actions taken upon the physical components of a quantum computer.

A given variational quantum circuit may be parameterized in a suitable device-specific manner. More generally, the quantum gates making up a quantum circuit may have an associated plurality of tuning parameters. For example, in embodiments based on optical switching, tuning parameters may correspond to the angles of individual optical elements.

In certain embodiments of quantum circuits, the quantum circuit includes both one or more gates and one or more measurement operations. Quantum computers implemented using such quantum circuits are referred to herein as implementing “measurement feedback.” For example, a quantum computer implementing measurement feedback may execute the gates in a quantum circuit and then measure only a subset (i.e., fewer than all) of the qubits in the quantum computer, and then decide which gate(s) to execute next based on the outcome(s) of the measurement(s). In particular, the measurement(s) may indicate a degree of error in the gate operation(s), and the quantum computer may decide which gate(s) to execute next based on the degree of error. The quantum computer may then execute the gate(s) indicated by the decision. This process of executing gates, measuring a subset of the qubits, and then deciding which gate(s) to execute next may be repeated any number of times. Measurement feedback may be useful for performing quantum error correction, but is not limited to use in performing quantum error correction. For every quantum circuit, there is an error-corrected implementation of the circuit with or without measurement feedback.

Some embodiments described herein generate, measure, or utilize quantum states that approximate a target quantum state (e.g., a ground state of a Hamiltonian). As will be appreciated by those trained in the art, there are many ways to quantify how well a first quantum state “approximates” a second quantum state. In the following description, any concept or definition of approximation known in the art may be used without departing from the scope hereof. For example, when the first and second quantum states are represented as first and second vectors, respectively, the first quantum state approximates the second quantum state when an inner product between the first and second vectors (called the “fidelity” between the two quantum states) is greater than a predefined amount (typically labeled E). In this example, the fidelity quantifies how “close” or “similar” the first and second quantum states are to each other. The fidelity represents a probability that a measurement of the first quantum state will give the same result as if the measurement were performed on the second quantum state. Proximity between quantum states can also be quantified with a distance measure, such as a Euclidean norm, a Hamming distance, or another type of norm known in the art. Proximity between quantum states can also be defined in computational terms. For example, the first quantum state approximates the second quantum state when a polynomial time-sampling of the first quantum state gives some desired information or property that it shares with the second quantum state.

Not all quantum computers are gate model quantum computers. Embodiments of the present invention are not limited to being implemented using gate model quantum computers. As an alternative example, embodiments of the present invention may be implemented, in whole or in part, using a quantum computer that is implemented using a quantum annealing architecture, which is an alternative to the gate model quantum computing architecture. More specifically, quantum annealing (QA) is a metaheuristic for finding the global minimum of a given objective function over a given set of candidate solutions (candidate states), by a process using quantum fluctuations.

FIG. 2B shows a diagram illustrating operations typically performed by a computer system 250 which implements quantum annealing. The system 250 includes both a quantum computer 252 and a classical computer 254. Operations shown on the left of the dashed vertical line 256 typically are performed by the quantum computer 252, while operations shown on the right of the dashed vertical line 256 typically are performed by the classical computer 254.

Quantum annealing starts with the classical computer 254 generating an initial Hamiltonian 260 and a final Hamiltonian 262 based on a computational problem 258 to be solved, and providing the initial Hamiltonian 260, the final Hamiltonian 262 and an annealing schedule 270 as input to the quantum computer 252. The quantum computer 252 prepares a well-known initial state 266 (FIG. 2B, operation 264), such as a quantum-mechanical superposition of all possible states (candidate states) with equal weights, based on the initial Hamiltonian 260. The classical computer 254 provides the initial Hamiltonian 260, a final Hamiltonian 262, and an annealing schedule 270 to the quantum computer 252. The quantum computer 252 starts in the initial state 266, and evolves its state according to the annealing schedule 270 following the time-dependent Schrodinger equation, a natural quantum-mechanical evolution of physical systems (FIG. 2B, operation 268). More specifically, the state of the quantum computer 252 undergoes time evolution under a time-dependent Hamiltonian, which starts from the initial Hamiltonian 260 and terminates at the final Hamiltonian 262. If the rate of change of the system Hamiltonian is slow enough, the system stays close to the ground state of the instantaneous Hamiltonian. If the rate of change of the system Hamiltonian is accelerated, the system may leave the ground state temporarily but produce a higher likelihood of concluding in the ground state of the final problem Hamiltonian, i.e., diabatic quantum computation. At the end of the time evolution, the set of qubits on the quantum annealer is in a final state 272, which is expected to be close to the ground state of the classical Ising model that corresponds to the solution to the original computational problem 258. An experimental demonstration of the success of quantum annealing for random magnets was reported immediately after the initial theoretical proposal.

The final state 272 of the quantum computer 252 is measured, thereby producing results 276 (i.e., measurements) (FIG. 2B, operation 274). The measurement operation 274 may be performed, for example, in any of the ways disclosed herein, such as in any of the ways disclosed herein in connection with the measurement unit 110 in FIG. 1. The classical computer 254 performs postprocessing on the measurement results 276 to produce output 280 representing a solution to the original computational problem 258 (FIG. 2B, operation 278).

As yet another alternative example, embodiments of the present invention may be implemented, in whole or in part, using a quantum computer that is implemented using a one-way quantum computing architecture, also referred to as a measurement-based quantum computing architecture, which is another alternative to the gate model quantum computing architecture. More specifically, the one-way or measurement based quantum computer (MBQC) is a method of quantum computing that first prepares an entangled resource state, usually a cluster state or graph state, then performs single qubit measurements on it. It is “one-way” because the resource state is destroyed by the measurements.

The outcome of each individual measurement is random, but they are related in such a way that the computation always succeeds. In general the choices of basis for later measurements need to depend on the results of earlier measurements, and hence the measurements cannot all be performed at the same time.

Any of the functions disclosed herein may be implemented using means for performing those functions. Such means include, but are not limited to, any of the components disclosed herein, such as the computer-related components described below.

Referring to FIG. 1, a diagram is shown of a system 100 implemented according to one embodiment of the present invention. Referring to FIG. 2A, a flowchart is shown of a method 200 performed by the system 100 of FIG. 1 according to one embodiment of the present invention. The system 100 includes a quantum computer 102. The quantum computer 102 includes a plurality of qubits 104, which may be implemented in any of the ways disclosed herein. There may be any number of qubits 104 in the quantum computer 102. For example, the qubits 104 may include or consist of no more than 2 qubits, no more than 4 qubits, no more than 8 qubits, no more than 16 qubits, no more than 32 qubits, no more than 64 qubits, no more than 128 qubits, no more than 256 qubits, no more than 512 qubits, no more than 1024 qubits, no more than 2048 qubits, no more than 4096 qubits, or no more than 8192 qubits. These are merely examples, in practice there may be any number of qubits 104 in the quantum computer 102.

There may be any number of gates in a quantum circuit. However, in some embodiments the number of gates may be at least proportional to the number of qubits 104 in the quantum computer 102. In some embodiments the gate depth may be no greater than the number of qubits 104 in the quantum computer 102, or no greater than some linear multiple of the number of qubits 104 in the quantum computer 102 (e.g., 2, 3, 4, 5, 6, or 7).

The qubits 104 may be interconnected in any graph pattern. For example, they be connected in a linear chain, a two-dimensional grid, an all-to-all connection, any combination thereof, or any subgraph of any of the preceding.

As will become clear from the description below, although element 102 is referred to herein as a “quantum computer,” this does not imply that all components of the quantum computer 102 leverage quantum phenomena. One or more components of the quantum computer 102 may, for example, be classical (i.e., non-quantum components) components which do not leverage quantum phenomena.

The quantum computer 102 includes a control unit 106, which may include any of a variety of circuitry and/or other machinery for performing the functions disclosed herein. The control unit 106 may, for example, consist entirely of classical components. The control unit 106 generates and provides as output one or more control signals 108 to the qubits 104. The control signals 108 may take any of a variety of forms, such as any kind of electromagnetic signals, such as electrical signals, magnetic signals, optical signals (e.g., laser pulses), or any combination thereof.

For example:
In embodiments in which some or all of the qubits 104 are implemented as photons (also referred to as a “quantum optical” implementation) that travel along waveguides, the control unit 106 may be a beam splitter (e.g., a heater or a mirror), the control signals 108 may be signals that control the heater or the rotation of the mirror, the measurement unit 110 may be a photodetector, and the measurement signals 112 may be photons.
In embodiments in which some or all of the qubits 104 are implemented as charge type qubits (e.g., transmon, X-mon, G-mon) or flux-type qubits (e.g., flux qubits, capacitively shunted flux qubits) (also referred to as a “circuit quantum electrodynamic” (circuit QED) implementation), the control unit 106 may be a bus resonator activated by a drive, the control signals 108 may be cavity modes, the measurement unit 110 may be a second resonator (e.g., a low-Q resonator), and the measurement signals 112 may be voltages measured from the second resonator using dispersive readout techniques.
In embodiments in which some or all of the qubits 104 are implemented as superconducting circuits, the control unit 106 may be a circuit QED-assisted control unit or a direct capacitive coupling control unit or an inductive capacitive coupling control unit, the control signals 108 may be cavity modes, the measurement unit 110 may be a second resonator (e.g., a low-Q resonator), and the measurement signals 112 may be voltages measured from the second resonator using dispersive readout techniques.
In embodiments in which some or all of the qubits 104 are implemented as trapped ions (e.g., electronic states of, e.g., magnesium ions), the control unit 106 may be a laser, the control signals 108 may be laser pulses, the measurement unit 110 may be a laser and either a CCD or a photodetector (e.g., a photomultiplier tube), and the measurement signals 112 may be photons.
In embodiments in which some or all of the qubits 104 are implemented using nuclear magnetic resonance (NMR) (in which case the qubits may be molecules, e.g., in liquid or solid form), the control unit 106 may be a radio frequency (RF) antenna, the control signals 108 may be RF fields emitted by the RF antenna, the measurement unit 110 may be another RF antenna, and the measurement signals 112 may be RF fields measured by the second RF antenna.
In embodiments in which some or all of the qubits 104 are implemented as nitrogen-vacancy centers (NV centers), the control unit 106 may, for example, be a laser, a microwave antenna, or a coil, the control signals 108 may be visible light, a microwave signal, or a constant electromagnetic field, the measurement unit 110 may be a photodetector, and the measurement signals 112 may be photons.
In embodiments in which some or all of the qubits 104 are implemented as two-dimensional quasiparticles called “anyons” (also referred to as a “topological quantum computer” implementation), the control unit 106 may be nanowires, the control signals 108 may be local electrical fields or microwave pulses, the measurement unit 110 may be superconducting circuits, and the measurement signals 112 may be voltages.
In embodiments in which some or all of the qubits 104 are implemented as semiconducting material (e.g., nanowires), the control unit 106 may be microfabricated gates, the control signals 108 may be RF or microwave signals, the measurement unit 110 may be microfabricated gates, and the measurement signals 112 may be RF or microwave signals.

Although not shown explicitly in FIG. 1 and not required, the measurement unit 110 may provide one or more feedback signals 114 to the control unit 106 based on the measurement signals 112. For example, quantum computers referred to as “one-way quantum computers” or “measurement-based quantum computers” utilize such feedback signals 114 from the measurement unit 110 to the control unit 106. Such feedback signals 114 are also necessary for the operation of fault-tolerant quantum computing and error correction.

The control signals 108 may, for example, include one or more state preparation signals which, when received by the qubits 104, cause some or all of the qubits 104 to change their states. Such state preparation signals constitute a quantum circuit also referred to as an “ansatz circuit.” The resulting state of the qubits 104 is referred to herein as an “initial state” or an “ansatz state.” The process of outputting the state preparation signal(s) to cause the qubits 104 to be in their initial state is referred to herein as “state preparation” (FIG. 2A, section 206). A special case of state preparation is “initialization,” also referred to as a “reset operation,” in which the initial state is one in which some or all of the qubits 104 are in the “zero” state i.e. the default single-qubit state. More generally, state preparation may involve using the state preparation signals to cause some or all of the qubits 104 to be in any distribution of desired states. In some embodiments, the control unit 106 may first perform initialization on the qubits 104 and then perform preparation on the qubits 104, by first outputting a first set of state preparation signals to initialize the qubits 104, and by then outputting a second set of state preparation signals to put the qubits 104 partially or entirely into non-zero states.

Another example of control signals 108 that may be output by the control unit 106 and received by the qubits 104 are gate control signals. The control unit 106 may output such gate control signals, thereby applying one or more gates to the qubits 104. Applying a gate to one or more qubits causes the set of qubits to undergo a physical state change which embodies a corresponding logical gate operation (e.g., single-qubit rotation, two-qubit entangling gate or multi-qubit operation) specified by the received gate control signal. As this implies, in response to receiving the gate control signals, the qubits 104 undergo physical transformations which cause the qubits 104 to change state in such a way that the states of the qubits 104, when measured (see below), represent the results of performing logical gate operations specified by the gate control signals. The term “quantum gate,” as used herein, refers to the application of a gate control signal to one or more qubits to cause those qubits to undergo the physical transformations described above and thereby to implement a logical gate operation.

It should be understood that the dividing line between state preparation (and the corresponding state preparation signals) and the application of gates (and the corresponding gate control signals) may be chosen arbitrarily. For example, some or all the components and operations that are illustrated in FIGS. 1 and 2A-2B as elements of “state preparation” may instead be characterized as elements of gate application. Conversely, for example, some or all of the components and operations that are illustrated in FIGS. 1 and 2A-2B as elements of “gate application” may instead be characterized as elements of state preparation. As one particular example, the system and method of FIGS. 1 and 2A-2B may be characterized as solely performing state preparation followed by measurement, without any gate application, where the elements that are described herein as being part of gate application are instead considered to be part of state preparation. Conversely, for example, the system and method of FIGS. 1 and 2A-2B may be characterized as solely performing gate application followed by measurement, without any state preparation, and where the elements that are described herein as being part of state preparation are instead considered to be part of gate application.

The quantum computer 102 also includes a measurement unit 110, which performs one or more measurement operations on the qubits 104 to read out measurement signals 112 (also referred to herein as “measurement results”) from the qubits 104, where the measurement results 112 are signals representing the states of some or all of the qubits 104. In practice, the control unit 106 and the measurement unit 110 may be entirely distinct from each other, or contain some components in common with each other, or be implemented using a single unit (i.e., a single unit may implement both the control unit 106 and the measurement unit 110). For example, a laser unit may be used both to generate the control signals 108 and to provide stimulus (e.g., one or more laser beams) to the qubits 104 to cause the measurement signals 112 to be generated.

In general, the quantum computer 102 may perform various operations described above any number of times. For example, the control unit 106 may generate one or more control signals 108, thereby causing the qubits 104 to perform one or more quantum gate operations. The measurement unit 110 may then perform one or more measurement operations on the qubits 104 to read out a set of one or more measurement signals 112. The measurement unit 110 may repeat such measurement operations on the qubits 104 before the control unit 106 generates additional control signals 108, thereby causing the measurement unit 110 to read out additional measurement signals 112 resulting from the same gate operations that were performed before reading out the previous measurement signals 112. The measurement unit 110 may repeat this process any number of times to generate any number of measurement signals 112 corresponding to the same gate operations. The quantum computer 102 may then aggregate such multiple measurements of the same gate operations in any of a variety of ways.

After the measurement unit 110 has performed one or more measurement operations on the qubits 104 after they have performed one set of gate operations, the control unit 106 may generate one or more additional control signals 108, which may differ from the previous control signals 108, thereby causing the qubits 104 to perform one or more additional quantum gate operations, which may differ from the previous set of quantum gate operations. The process described above may then be repeated, with the measurement unit 110 performing one or more measurement operations on the qubits 104 in their new states (resulting from the most recently-performed gate operations).

In general, the system 100 may implement a plurality of quantum circuits as follows. For each quantum circuit C in the plurality of quantum circuits (FIG. 2A, operation 202), the system 100 performs a plurality of “shots” on the qubits 104. The meaning of a shot will become clear from the description that follows. For each shot S in the plurality of shots (FIG. 2A, operation 204), the system 100 prepares the state of the qubits 104 (FIG. 2A, section 206). More specifically, for each quantum gate Gin quantum circuit C (FIG. 2A, operation 210), the system 100 applies quantum gate G to the qubits 104 (FIG. 2A, operations 212 and 214).

Then, for each of the qubits Q 104 (FIG. 2A, operation 216), the system 100 measures the qubit Q to produce measurement output representing a current state of qubit Q (FIG. 2A, operations 218 and 220).

The operations described above are repeated for each shot S (FIG. 2A, operation 222), and circuit C (FIG. 2A, operation 224). As the description above implies, a single “shot” involves preparing the state of the qubits 104 and applying all of the quantum gates in a circuit to the qubits 104 and then measuring the states of the qubits 104; and the system 100 may perform multiple shots for one or more circuits.

Referring to FIG. 3, a diagram is shown of a hybrid quantum classical (HQC) computer 300 implemented according to one embodiment of the present invention. The HQC 300 includes a quantum computer component 102 (which may, for example, be implemented in the manner shown and described in connection with FIG. 1) and a classical computer component 306. The classical computer component may be a machine implemented according to the general computing model established by John Von Neumann, in which programs are written in the form of ordered lists of instructions and stored within a classical (e.g., digital) memory 310 and executed by a classical (e.g., digital) processor 308 of the classical computer. The memory 310 is classical in the sense that it stores data in a storage medium in the form of bits, which have a single definite binary state at any point in time. The bits stored in the memory 310 may, for example, represent a computer program. The classical computer component 304 typically includes a bus 314. The processor 308 may read bits from and write bits to the memory 310 over the bus 314. For example, the processor 308 may read instructions from the computer program in the memory 310, and may optionally receive input data 316 from a source external to the computer 302, such as from a user input device such as a mouse, keyboard, or any other input device. The processor 308 may use instructions that have been read from the memory 310 to perform computations on data read from the memory 310 and/or the input 316, and generate output from those instructions. The processor 308 may store that output back into the memory 310 and/or provide the output externally as output data 318 via an output device, such as a monitor, speaker, or network device.

The quantum computer component 102 may include a plurality of qubits 104, as described above in connection with FIG. 1. A single qubit may represent a one, a zero, or any quantum superposition of those two qubit states. The classical computer component 304 may provide classical state preparation signals 332 to the quantum computer 102, in response to which the quantum computer 102 may prepare the states of the qubits 104 in any of the ways disclosed herein, such as in any of the ways disclosed in connection with FIGS. 1 and 2A-2B.

Once the qubits 104 have been prepared, the classical processor 308 may provide classical control signals 334 to the quantum computer 102, in response to which the quantum computer 102 may apply the gate operations specified by the control signals 332 to the qubits 104, as a result of which the qubits 104 arrive at a final state. The measurement unit 110 in the quantum computer 102 (which may be implemented as described above in connection with FIGS. 1 and 2A-2B) may measure the states of the qubits 104 and produce measurement output 338 representing the collapse of the states of the qubits 104 into one of their eigenstates. As a result, the measurement output 338 includes or consists of bits and therefore represents a classical state. The quantum computer 102 provides the measurement output 338 to the classical processor 308. The classical processor 308 may store data representing the measurement output 338 and/or data derived therefrom in the classical memory 310.

The steps described above may be repeated any number of times, with what is described above as the final state of the qubits 104 serving as the initial state of the next iteration. In this way, the classical computer 304 and the quantum computer 102 may cooperate as co-processors to perform joint computations as a single computer system.

Although certain functions may be described herein as being performed by a classical computer and other functions may be described herein as being performed by a quantum computer, these are merely examples and do not constitute limitations of the present invention. A subset of the functions which are disclosed herein as being performed by a quantum computer may instead be performed by a classical computer. For example, a classical computer may execute functionality for emulating a quantum computer and provide a subset of the functionality described herein, albeit with functionality limited by the exponential scaling of the simulation. Functions which are disclosed herein as being performed by a classical computer may instead be performed by a quantum computer.

The techniques described above may be implemented, for example, in hardware, in one or more computer programs tangibly stored on one or more computer-readable media, firmware, or any combination thereof, such as solely on a quantum computer, solely on a classical computer, or on a hybrid quantum classical (HQC) computer. The techniques disclosed herein may, for example, be implemented solely on a classical computer, in which the classical computer emulates the quantum computer functions disclosed herein.

Any reference herein to the state 10) may alternatively refer to the state 11), and vice versa. In other words, any role described herein for the states 10) and11) may be reversed within embodiments of the present invention. More generally, any computational basis state disclosed herein may be replaced with any suitable reference state within embodiments of the present invention.

The techniques described above may be implemented in one or more computer programs executing on (or executable by) a programmable computer (such as a classical computer, a quantum computer, or an HQC) including any combination of any number of the following: a processor, a storage medium readable and/or writable by the processor (including, for example, volatile and non-volatile memory and/or storage elements), an input device, and an output device. Program code may be applied to input entered using the input device to perform the functions described and to generate output using the output device.

Embodiments of the present invention include features which are only possible and/or feasible to implement with the use of one or more computers, computer processors, and/or other elements of a computer system. Such features are either impossible or impractical to implement mentally and/or manually. For example, embodiments of the present invention initialize a quantum component to an initial state with qubit registers and estimate the ground state energy of a Hamiltonian (H) matrix that characterizes a physical system. Such functions are inherently rooted in quantum computing technology and cannot be performed mentally or manually.

Any claims herein which affirmatively require a computer, a processor, a memory, or similar computer-related elements, are intended to require such elements, and should not be interpreted as if such elements are not present in or required by such claims. Such claims are not intended, and should not be interpreted, to cover methods and/or systems which lack the recited computer-related elements. For example, any method claim herein which recites that the claimed method is performed by a computer, a processor, a memory, and/or similar computer-related element, is intended to, and should only be interpreted to, encompass methods which are performed by the recited computer-related element(s). Such a method claim should not be interpreted, for example, to encompass a method that is performed mentally or by hand (e.g., using pencil and paper). Similarly, any product claim herein which recites that the claimed product includes a computer, a processor, a memory, and/or similar computer-related element, is intended to, and should only be interpreted to, encompass products which include the recited computer-related element(s). Such a product claim should not be interpreted, for example, to encompass a product that does not include the recited computer-related element(s).

In embodiments in which a classical computing component executes a computer program providing any subset of the functionality within the scope of the claims below, the computer program may be implemented in any programming language, such as assembly language, machine language, a high-level procedural programming language, or an object-oriented programming language. The programming language may, for example, be a compiled or interpreted programming language.

Each such computer program may be implemented in a computer program product tangibly embodied in a machine-readable storage device for execution by a computer processor, which may be either a classical processor or a quantum processor. Method steps of the invention may be performed by one or more computer processors executing a program tangibly embodied on a computer-readable medium to perform functions of the invention by operating on input and generating output. Suitable processors include, by way of example, both general and special purpose microprocessors. Generally, the processor receives (reads) instructions and data from a memory (such as a read-only memory and/or a random access memory) and writes (stores) instructions and data to the memory. Storage devices suitable for tangibly embodying computer program instructions and data include, for example, all forms of non-volatile memory, such as semiconductor memory devices, including EPROM, EEPROM, and flash memory devices; magnetic disks such as internal hard disks and removable disks; magneto-optical disks; and CD-ROMs. Any of the foregoing may be supplemented by, or incorporated in, specially-designed ASICs (application-specific integrated circuits) or FPGAs (Field-Programmable Gate Arrays). A classical computer can generally also receive (read) programs and data from, and write (store) programs and data to, a non-transitory computer-readable storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium.

Any data disclosed herein may be implemented, for example, in one or more data structures tangibly stored on a non-transitory computer-readable medium (such as a classical computer-readable medium, a quantum computer-readable medium, or an HQC computer-readable medium). Embodiments of the invention may store such data in such data structure(s) and read such data from such data structure(s).

Although terms such as “optimize” and “optimal” are used herein, in practice, embodiments of the present invention may include methods which produce outputs that are not optimal, or which are not known to be optimal, but which nevertheless are useful. For example, embodiments of the present invention may produce an output which approximates an optimal solution, within some degree of error. As a result, terms herein such as “optimize” and “optimal” should be understood to refer not only to processes which produce optimal outputs, but also processes which produce outputs that approximate an optimal solution, within some degree of error.

What is claimed is:

1. A method for estimating a ground state property [symbol] ψ₀|O|ψ₀ [symbol] of an observable (O), performed on a hybrid quantum-classical computer, the computer comprising a quantum computing component having a plurality of qubits, and a classical computing component comprising at least one processor and a non-transitory computer-readable memory, the non-transitory computer-readable memory storing computer instructions, which, when executed by the classical processor, perform the method, the method comprising:
initializing the quantum component to an initial state with qubit registers;
estimating the ground state energy of a Hamiltonian (H) matrix that characterizes a physical system;
generating a plurality of samples from a parameterized Hadamard test circuit;
evaluating the sample outcomes;
estimating the expectation value (p₀) of the observable (O) with respect to the ground state energy;
estimating the weighted expectation value p₀O₀; and
from the weighted expectation value, deriving an estimate of the ground state property [symbol] ψ₀|O|ψ₀ [symbol] .

2. The method of claim 1, wherein initializing the quantum component to the initial state comprises initializing the quantum component to the initial state with the qubit registers and a single ancilla qubit.

3. The method of claim 1, further comprising computing Green's functions using the ground state property [symbol] ψ₀|O|ψ₀ [symbol] .

4. The method of claim 3, wherein computing Green's functions comprises computing Green's functions to compute electron transport in materials.

5. The method of claim 3, wherein computing Green's functions comprises computing Green's functions to compute electric dipoles of molecules.

6. The method of claim 1, wherein the physical system comprises a molecule.

7. The method of claim 6, further comprising computing the charge density of the molecule.

8. The method of claim 7, wherein computing the charge density of the molecule comprises computing the charge density of the molecule from the one-particle reduced density matrix.

9. The method of claim 1, wherein the physical system comprises a material.

10. The method of claim 1, where deriving the estimate of the ground state property comprises deriving the estimate of the ground state property using a low-depth quantum circuit with reduced error rates.

11. The method of claim 10, wherein the quantum circuit depth of the low-depth quantum circuit is linear in the inverse spectral gap and poly-logarithmic in the inverse target accuracy and inverse initial overlap.

12. The method of claim 1, further comprising using the using the ground state property [symbol] ψ₀|O|ψ₀ [symbol] to generate a quantum state approximately proportional to a solution of a linear system of equations.

13. The method of claim 1, wherein initializing the quantum component to the initial state comprises executing a variational quantum eigensolver (VQE).

14. The method of claim 1, wherein initializing the quantum component to the initial state comprises executing a quantum approximate optimization algorithm (QAQO).

15. A quantum-classical algorithm for estimating a ground state property of an observable (O), wherein the algorithm (1) estimates ground state energy, (2) estimates the expectation value of the observable (O) with respect to the ground state p₀, and (3) estimates the weighted expectation values p₀O₀.

16. A system for estimating a ground state property [symbol] ψ₀|O|ψ₀ [symbol] of an observable (O), the system comprising a hybrid quantum-classical computer (HQC), the HQC computer comprising a quantum computing component having a plurality of qubits and a classical computing component comprising at least one processor and a non-transitory computer-readable memory, the non-transitory computer-readable memory storing computer instructions, which, when executed by the classical processor, perform a method for estimating the ground state property [symbol] ψ₀|O|ψ₀ [symbol] of the observable (O), the method, comprising:
initializing the quantum component to an initial state with qubit registers;
estimating the ground state energy of a Hamiltonian (H) matrix that characterizes a physical system;
generating a plurality of samples from a parameterized Hadamard test circuit;
evaluating the sample outcomes;
estimating the expectation value (p₀) of the observable (O) with respect to the ground state energy;
estimating the weighted expectation value p₀O₀; and
from the weighted expectation value, deriving an estimate of the ground state property [symbol] ψ₀|O|ψ₀ [symbol] .

17. The system of claim 16, wherein initializing the quantum component to the initial state comprises initializing the quantum component to the initial state with the qubit registers and a single ancilla qubit.

18. The system of claim 16, wherein the method further comprises computing Green's functions using the ground state property [symbol] ψ₀|O|ψ₀ [symbol] .

19. The system of claim 18, wherein computing Green's functions comprises computing Green's functions to compute electron transport in materials.

20. The system of claim 18, wherein computing Green's functions comprises computing Green's functions to compute electric dipoles of molecules.

21. The system of claim 16, wherein the physical system comprises a molecule.

22. The system of claim 21, wherein the method further comprises computing the charge density of the molecule.

23. The system of claim 22, wherein computing the charge density of the molecule comprises computing the charge density of the molecule from the one-particle reduced density matrix.

24. The system of claim 16, wherein the physical system comprises a material.

25. The system of claim 16, where deriving the estimate of the ground state property comprises deriving the estimate of the ground state property using a low-depth quantum circuit with reduced error rates.

26. The system of claim 25, wherein the quantum circuit depth of the low-depth quantum circuit is linear in the inverse spectral gap and poly-logarithmic in the inverse target accuracy and inverse initial overlap.

27. The system of claim 16, wherein the method further comprises using the using the ground state property [symbol] ψ₀|O|ψ₀ [symbol] to generate a quantum state approximately proportional to a solution of a linear system of equations.

28. The system of claim 16, wherein initializing the quantum component to the initial state comprises executing a variational quantum eigensolver (VQE).

29. The system of claim 16, wherein initializing the quantum component to the initial state comprises executing a quantum approximate optimization algorithm (QAQO).
